(19) United States
(12) Patent Application Publication
(10) Pub. No.: US 2012/0207400 A1
(43) Pub. Date: Aug. 16, 2012

(54) IMAGE CODING METHOD, IMAGE CODING APPARATUS, IMAGE DECODING METHOD, IMAGE DECODING APPARATUS, AND IMAGE CODING AND DECODING APPARATUS

(76) Inventors: Hisao SASAI, Osaka (JP); Takahiro Nishi, Nara (JP); Youji Shibahara, Osaka (JP); Toshiyasu Sugio, Osaka (JP)

(21) Appl. No.: 13/368,447

(22) Filed: Feb. 8, 2012

Related U.S. Application Data
(60) Provisional application No. 61/441,341, filed on Feb. 10, 2011.
(60) Provisional application No. 61/441,374, filed on Feb. 10, 2011.

(51) Int. Cl. G06K 9/36

(52) U.S. Cl. 382/233; 382/232

(57) ABSTRACT

An image coding method of compressing and coding image data includes: binariziang a plurality of coefficients to generate a binary signal, the plurality of coefficients being included in a unit of processing of the image data in a frequency domain; determining a context to be used for arithmetic coding of the plurality of coefficients, based on a position of a last non-zero coefficient in a scan order among one or more non-zero coefficients included in the unit of processing; performing arithmetic coding on the binary signal using probability information corresponding to the determined context; and updating, based on the binary signal, the probability information corresponding to the determined context.

### CROSS REFERENCE TO RELATED APPLICATIONS

The present application claims the benefit of U.S. Provisional Patent Applications No. 61/441,341 and No. 61/441,374 filed on Feb. 10, 2011. The entire disclosures of the above-identified applications, including the specifications, drawings and claims are incorporated herein by reference in their entirety.

### TECHNICAL FIELD

The present invention relates to image coding methods, image coding apparatuses, image decoding methods, image decoding apparatuses, and image coding and decoding apparatuses, and particularly relates to an image coding method, an image coding apparatus, an image decoding method, an image decoding apparatus, and an image coding and decoding apparatus in each of which one or both of arithmetic coding and arithmetic decoding is or are performed.

### BACKGROUND ART

In recent years, there have been an increasing number of applications for providing services via the Internet (such as video-on-demand type services including video conferences, digital video broadcasting and streaming of video content). These applications depend on transmission of video data. At the time of transmission of video data by these applications, a large part of the video data is transmitted through a conventional transmission path of a limited bandwidth. Furthermore, at the time of recording of video data by these applications, a large part of the video data is recorded onto a conventional recording medium with limited storage capacity. In order to transmit video data through a conventional transmission path or to record video data onto a conventional recording medium, it is essential to compress or reduce the amount of video data.

Thus, a plurality of video coding standards has been developed for compressing video data. Such video coding standards include, for example, the ITU-T standards denoted as H. 26x, produced by the telecommunication standardization sector of the international telecommunication union, and the ISO/IEC standards denoted as MPEG-x. The most up-to-date and advanced video coding standard is currently the standard denoted as H.264/AVC or MPEG-4 AVC (see Non-Patent Literature 1 and Non-Patent Literature 2).

In the H.264/AVC standard, the coding process roughly includes prediction, transform, quantization, and entropy coding. Through the entropy coding, redundant information is cut from information which is used in the prediction, quantized information, and the like. The known examples of the entropy coding include variable-length coding, adaptive coding, and fixed-length coding. The variable-length coding includes Huffman coding, run-length coding, and arithmetic coding.

Of these, the arithmetic coding is a method in which the probability of occurrence of a symbol is calculated to determine an output code. Since a code is determined according to characteristics of image data in the arithmetic coding, the arithmetic coding is known for higher coding efficiency than Huffman coding or the like which uses a fixed coding table.

In particular, context-based adaptive binary arithmetic coding (CABAC) provides high coding efficiency in a manner that arithmetic coding is performed on a binary signal while a symbol occurrence probability is updated for each context determined based on characteristics of image data.

### CITATION LIST

### Non Patent Literature

[Non Patent Literature 1] ISO/IEC 14496-10 “MPEG-4 Part10 Advanced Video Coding”
[Non Patent Literature 2] Thomas Wiegand et al, “Overveiw of the H.264/AVC Video Coding Standard”, IEEE TRANSACTIONS ON CIRCUITS AND SYSTEMS FOR VIDEO TECHNOLOGY, JULY 2003, PP. 1-19.

### SUMMARY OF INVENTION

### Technical Problem

However, it is difficult to appropriately determine a context in CABAC. For example, when the same context is used for binary signals which are largely different in the symbol occurrence probability, the accuracy of predicting the symbol occurrence probability will decrease. As a result, the coding efficiency will decrease, which is a problem.

Thus, the present invention has been devised to solve the above conventional problem and has an object to provide an image coding method, an image decoding method, and the like, in which a context for arithmetic coding can be appropriately determined and thereby the coding efficiency can be improved, in the context-based adaptive binary arithmetic coding.

### Solution to Problem

In order to achieve the above object, an image coding method according to an aspect of the present invention is an image coding method of compressing and coding image data, the method comprising: binarizing a plurality of coefficients to generate a binary signal, the plurality of coefficients being included in a unit of processing of the image data in a frequency domain; determining a context to be used for arithmetic coding of the plurality of coefficients, based on a position of a last non-zero coefficient in a scan order among one or more non-zero coefficients included in the unit of processing; performing arithmetic coding on the binary signal using probability information corresponding to the determined context; and updating, based on the binary signal, the probability information corresponding to the determined context.

In order to achieve the above object, an image coding apparatus according to an aspect of the present invention is an image coding apparatus which compresses and codes image data, the apparatus comprising: a binarization unit configured to binarize a plurality of coefficients to generate a binary signal, the plurality of coefficients being included in a unit of processing in a frequency domain obtained by frequency-transforming the image data; a context control unit configured to (i) determine a context to be used for arithmetic coding of the plurality of coefficients, based on a position of a last non-zero coefficient in a scan order among one or more non-zero coefficients included in the unit of processing and (ii) update, based on the binary signal, probability information corresponding to the determined context; and a binary arithmetic coding unit configured to perform arithmetic coding on the binary signal using the probability information corresponding to the determined context.

In order to achieve the above object, an image decoding method according to an aspect of the present invention is an image decoding method of decoding compressed and coded image data, the method comprising: determining a context to be used for arithmetic decoding of an input signal corresponding to a plurality of coefficients included in a unit of processing of the image data in a frequency domain, based on a position of a last non-zero coefficient in a scan order among one or more non-zero coefficients included in the unit of processing; performing arithmetic decoding on the input signal using probability information corresponding to the determined context, to generate a binary signal; updating, based on the binary signal, the probability information corresponding to the determined context; and reconstructing, using the binary signal, the plurality of coefficients included in the unit of processing.

In order to achieve the above object, an image decoding apparatus according to an aspect of the present invention is an image decoding apparatus which decodes compressed and coded image data, the apparatus comprising: a context control unit configured to (i) determine a context to be used for arithmetic decoding of an input signal corresponding to a plurality of coefficients included in a unit of processing of the image data in a frequency domain, based on a position of a last non-zero coefficient in a scan order among one or more non-zero coefficients included in the unit of processing and (ii) update, based on a binary signal, probability information corresponding to the determined context; a binary arithmetic decoding unit configured to perform arithmetic decoding on the input signal using the probability information corresponding to the determined context, to generate the binary signal; and a coefficient reconstruction unit configured to reconstruct, using the binary signal, the plurality of coefficients included in the unit of processing.

In order to achieve the above object, an image coding and decoding apparatus according to an aspect of the present invention comprises the above image coding apparatus and the above image decoding apparatus.

### Advantageous Effects of Invention

According to the present invention, a context for arithmetic coding can be appropriately determined, which allows improvement in the coding efficiency, in the context-based adaptive binary arithmetic coding.

### BRIEF DESCRIPTION OF DRAWINGS

These and other objects, advantages and features of the invention will become apparent from the following description thereof taken in conjunction with the accompanying drawings that illustrate a specific embodiment of the present invention. In the Drawings:

FIG. 1 is a block diagram showing a structure of a conventional arithmetic coding apparatus;

FIG. 2 is a flowchart showing a conventional arithmetic coding method;

FIG. 3 schematically illustrates the conventional arithmetic coding method;

FIG. 4 is a block diagram showing an example of a structure of an arithmetic coding unit according to Embodiment 1 of the present invention;

FIG. 5 is a flowchart showing an example of processing operation of an arithmetic coding unit according to Embodiment 1 of the present invention;

FIG. 6 shows an example of a symbol occurrence probability table according to Embodiment 1 of the present invention;

FIG. 7 shows an example of a context table according to Embodiment 1 of the present invention;

FIG. 8 schematically illustrates an example of a binarization method according to Embodiment 1 of the present invention;

FIG. 9A shows an example of a binarization result of end position information according to Embodiment 1 of the present invention;

FIG. 9B shows an example of the binarization result of the end position information according to Embodiment 1 of the present invention;

FIG. 9C shows an example of the binarization result of the end position information according to Embodiment 1 of the present invention;

FIG. 9D shows an example of the binarization result of the end position information according to Embodiment 1 of the present invention;

FIG. 10 is a flowchart showing an example of an arithmetic coding method for the end position information according to Embodiment 1 of the present invention;

FIG. 11 is a flowchart showing an example of the arithmetic coding method for the end position information according to Embodiment 1 of the present invention;

FIG. 12 is a flowchart showing another example of the arithmetic coding method for the end position information according to Embodiment 1 of the present invention;

FIG. 13 is a flowchart showing an example of the arithmetic coding method for coefficient information according to Embodiment 1 of the present invention;

FIG. 14 is a block diagram showing an example of a structure of an image coding apparatus according to Embodiment 1 of the present invention;

FIG. 15 is a block diagram showing an example of a structure of an arithmetic coding unit according to an implementation of the present invention;

FIG. 16 is a flowchart showing an example of processing operation of an arithmetic coding unit according to an implementation of the present invention;

FIG. 17 is a block diagram showing an example of a structure of an arithmetic decoding unit according to Embodiment 2 of the present invention;

FIG. 18 is a flowchart showing an example of processing operation of an arithmetic decoding unit according to Embodiment 2 of the present invention;

FIG. 19 is a flowchart showing an example of the arithmetic decoding method for the end position information according to Embodiment 2 of the present invention;

FIG. 20 is a flowchart showing another example of the arithmetic decoding method for the end position information according to Embodiment 2 of the present invention;

FIG. 21 is a flowchart showing an example of an arithmetic decoding method for the coefficient information according to Embodiment 2 of the present invention;

FIG. 22 is a block diagram showing an example of a structure of an image decoding apparatus according to Embodiment 2 of the present invention;

FIG. 23 is a block diagram showing an example of a structure of an arithmetic decoding unit according to an implementation of the present invention;

FIG. 24 is a flowchart showing an example of processing operation of an arithmetic decoding unit according to an embodiment of the present invention;

FIG. 25 illustrates an overall configuration of a content providing system for implementing content distribution services;

FIG. 26 illustrates an overall configuration of a digital broadcasting system;

FIG. 27 is a block diagram illustrating an example of a configuration of a television;

FIG. 28 is a block diagram illustrating an example of a configuration of an information reproducing/recording unit that reads and writes information from and on a recording medium that is an optical disk;

FIG. 29 shows an example of a configuration of a recording medium that is an optical disk;

FIG. 30A shows an example of a cellular phone. FIG. 30B is a block diagram showing an example of a configuration of the cellular phone;

FIG. 31 illustrates a structure of the multiplexed data;

FIG. 32 schematically illustrates how each of streams is multiplexed in multiplexed data;

FIG. 33 illustrates how a video stream is stored in a stream of PES packets in more detail;

FIG. 34 shows a structure of TS packets and source packets in the multiplexed data;

FIG. 35 shows a data structure of a PMT;

FIG. 36 illustrates an internal structure of multiplexed data information;

FIG. 37 shows an internal structure of stream attribute information;

FIG. 38 shows steps for identifying video data;

FIG. 39 is a block diagram illustrating an example of a configuration of an integrated circuit for implementing the moving picture coding method and the moving picture decoding method according to each of Embodiments;

FIG. 40 shows a configuration for switching between driving frequencies;

FIG. 41 shows steps for identifying video data and switching between driving frequencies;

FIG. 42 shows an example of a look-up table in which standards of video data are associated with the driving frequencies; and

FIG. 43A shows, an example of a configuration for sharing a module of a signal processing unit. FIG. 43B is a diagram showing another example of a configuration for sharing a module of a signal processing unit.

### DESCRIPTION OF EMBODIMENTS

As an introduction, how the present invention has been attained is described.

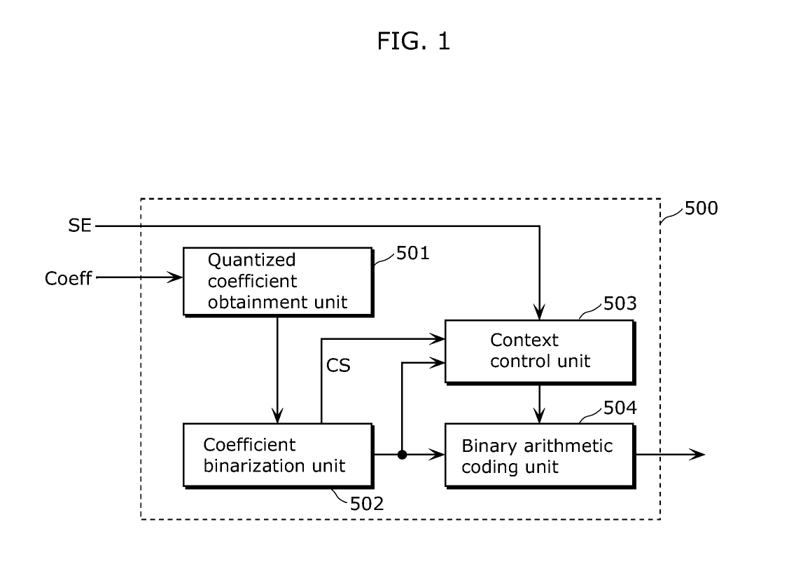

First, with reference to FIGS. 1 to 3, the conventional operation of arithmetic coding of quantized coefficient information (i.e., quantized coefficients) is described. Here, out of the arithmetic coding of the quantized coefficients, arithmetic coding of information particularly indicating which coefficient has a value of zero (zero coefficient) and which coefficient has a value other than zero (non-zero coefficient) is described.

FIG. 1 is a block diagram showing a structure of a conventional arithmetic coding unit using the H.264/AVC standard. An arithmetic coding unit 500 performs arithmetic coding on the quantized coefficients. As shown in FIG. 1, the arithmetic coding unit 500 includes a quantized coefficient obtainment unit 501, a coefficient binarization unit 502, a context control unit 503, and a binary arithmetic coding unit 504. The context control unit 503 includes a memory for storing a symbol occurrence probability corresponding to a context.

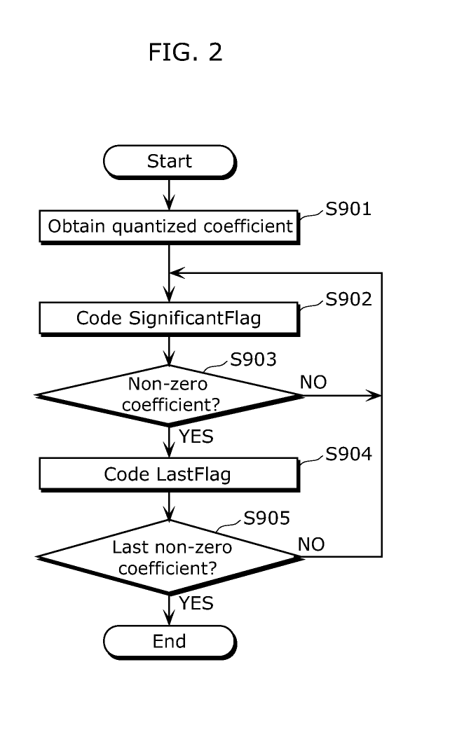

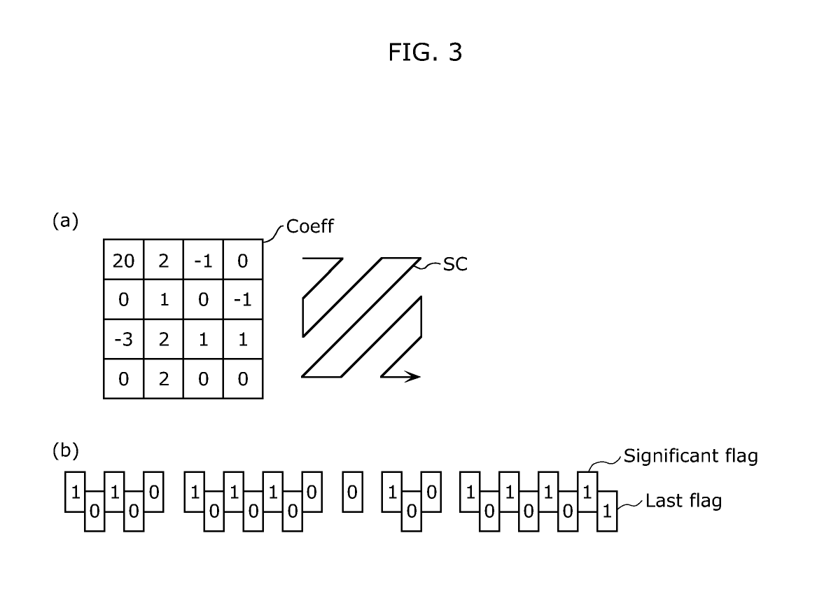

As shown in FIG. 2, the quantized coefficient obtainment unit 501 first obtains a coefficient signal Coeff (Step S901). Here, the coefficient signal Coeff includes a plurality of quantized coefficients corresponding a block to be coded (a unit of processing). In other words, the coefficient signal Coeff corresponds to a unit of processing in a frequency domain. Specifically, the coefficient signal Coeff represents a quantized coefficient group indicated in (a) of FIG. 3, for example.

Next, the quantized coefficient obtainment unit 501 outputs the obtained coefficient signal Coeff to the coefficient binarization unit 502. Subsequently, the coefficient binarization unit 502 reads, in a predetermined order (scan order, for example, a zigzag order indicated in (a) of FIG. 3), the plurality of quantized coefficients included in the obtained coefficient signal Coeff. The coefficient binarization unit 502 then performs binarization on the read quantized coefficients (processing target coefficients).

Here, the coefficient binarization unit 502 generates, as a part of a binary signal, information (SignificantFlag) indicating whether the processing target coefficient is a zero coefficient or a non-zero coefficient (for example, binary data (symbol) indicating 1 for a non-zero coefficient and 0 for a zero coefficient). The coefficient binarization unit 502 then outputs SignificantFlag to the binary arithmetic coding unit 504.

The context control unit 503 obtains coefficient position information CS on the processing target coefficient, and signal type information SE (for example, block size information). The context control unit 503 then outputs, to the binary arithmetic coding unit 504, the symbol occurrence probability necessary for the arithmetic coding of SignificantFlag, based on the coefficient position information CS and the signal type information SE.

The binary arithmetic coding unit 504 performs arithmetic coding on SignificantFlag using the above-described symbol occurrence probability (Step S902). When the processing target coefficient is a zero-coefficient (NO in Step S903), the coefficient binarization unit 502 performs, in the same or like manner as above, the arithmetic coding on SignificantFlag for the quantized coefficient which comes next in the scan order.

On the other hand, when the processing target coefficient is a non-zero coefficient (YES in Step S903), the coefficient binarization unit 502 generates, as another part of the binary signal, information (LastFlag) indicating whether or not, among the non-zero coefficients included in the coefficient signal Coeff, the processing target coefficient is the last non-zero coefficient in the scan order (for example, binary data indicating 1 for the case where the processing target coefficient is the last non-zero coefficient and 0 for the case where the processing target coefficient is not the last non-zero coefficient). The coefficient binarization unit 502 then outputs LastFlag to the binary arithmetic coding unit 504.

As in the case of SignificantFlag, the context control unit 503 outputs, to the binary arithmetic coding unit 504, the symbol occurrence probability necessary for the arithmetic coding of LastFlag.

The binary arithmetic coding unit 504 performs arithmetic coding on LastFlag using the above-described symbol occurrence probability (Step S904). Here, when the processing target coefficient is not the last non-zero coefficient (NO in Step S905), the coefficient binarization unit 502 performs, in the same or like manner as above, the arithmetic coding on SignificantFlag for the quantized coefficient which comes next in the scan order. On the other hand, when the processing target coefficient is the last non-zero coefficient (YES in Step S905), it ends the coding of SignificantFlag and LastFlag for the coefficient signal Coeff.

It is to be noted that, for example, when the arithmetic coding is performed as described above on the coefficient signal Coeff shown in (a) of FIG. 3, binary arithmetic coding is performed on the binary signal shown in (b) of FIG. 3. Here, the signal indicated in the upper level is SignificantFlag while the signal indicated in the lower level is LastFlag. On this binary signal, the binary arithmetic coding is performed in sequence from left to right.

It is to be noted that the context control unit 503 obtains the binary signal from the coefficient binarization unit 502. Every time the binary arithmetic coding is performed on a binary symbol included in the binary signal, the context control unit 503 then updates, based on the binary symbol, a symbol occurrence probability which corresponds to a context used in the binary arithmetic coding.

In the above-described manner, the arithmetic coding is performed on the coefficient signal Coeff. However, in the case of the above arithmetic coding, it is very difficult for the context control unit 503 to appropriately determine a context based on the signal type information on a target signal.

For example, in the case of performing the arithmetic coding on the quantized coefficients obtained per block size, a different context is determined for each position within the block of the quantized coefficients. Even with an increased block size, a context is determined likewise for each position. When the contexts are classified in detail as above, there is a decreased occurrence frequency of updating process for the occurrence probability which corresponds to each of the contexts, and it is therefore difficult to perform control adapted to characteristics of image data, which is an advantage of the arithmetic coding, with the result that the coding efficiency deteriorates.

Furthermore, since coding of SignificantFlag and coding of LastFlag are alternately performed, switching of processing steps is frequent, which reduces the processing efficiency.

Thus, it is conceivable that, instead of LastFlag, the information which indicates the position of the last non-zero coefficient in the scan order is coded prior to SignificantFlag. Also in such a case, it is necessary that the context be appropriately controlled and the coding efficiency thereby be improved.

Thus, an image coding method according to an aspect of the present invention is an image coding method of compressing and coding image data, the method comprising: binarizing a plurality of coefficients to generate a binary signal, the plurality of coefficients being included in a unit of processing of the image data in a frequency domain; determining a context to be used for arithmetic coding of the plurality of coefficients, based on a position of a last non-zero coefficient in a scan order among one or more non-zero coefficients included in the unit of processing; performing arithmetic coding on the binary signal using probability information corresponding to the determined context; and updating, based on the binary signal, the probability information corresponding to the determined context.

With this, a context for arithmetic coding of a plurality of coefficients can be determined based on the position of the last non-zero coefficient in the scan order. Generally, with the last non-zero coefficient at a different position, the symbol occurrence frequency is often different in the binary signal obtained by binariziing the plurality of coefficients included in the unit of processing. By determining a context based on the position of the last non-zero coefficient, it is therefore possible to perform the arithmetic coding using more appropriate probability information and thereby improve the coding efficiency.

Furthermore, in an image coding method according to another aspect of the present invention, it is desirable that the position of the last non-zero coefficient be represented in a two-dimensional orthogonal coordinate system, and in the determining, the context be determined based on at least one of two coordinate values that indicate the position of the last non-zero coefficient.

With this, a context can be easily determined using coordinate values in the case where the position of the last non-zero coefficient is represented in the two-dimensional orthogonal coordinate system.

Furthermore, in an image coding method according to another aspect of the present invention, it is desirable that in the determining, the context be determined based on a sum of the two coordinate values.

With this, a context can be determined based on a sum of the coordinate values. This means that a context can be appropriately determined based on the magnitude of the frequency component which corresponds to the position of the last non-zero coefficient.

Furthermore, in an image coding method according to another aspect of the present invention, it is desirable that in the determining, the context be determined based only on a larger one of the two coordinate values.

With this, a context can be determined based on the maximum value of the coordinate values. This means that a context can be appropriately determined based on the magnitude of the high-frequency component included in the frequency component which corresponds to the position of the last non-zero coefficient.

Furthermore, in an image coding method according to another aspect of the present invention, it is desirable that in the binarizing, the binary signal be generated by binarizing, in a reverse order of the scan order, a level which indicates a magnitude of each of the one or more non-zero coefficients included in the unit of processing, and in the determining, for each of the one or more non-zero coefficients included in the unit of processing, a context for arithmetic coding of the non-zero coefficient be determined based on the position of the last non-zero coefficient and the number of non-zero coefficients each of which has a level value exceeding a predetermined value among one or more non-zero coefficients located at and before the non-zero coefficient in the reverse order of the scan order.

With this, a context can be determined based on not only the position of the last non-zero coefficient in the scan order, but also the number of non-zero coefficients each of which has a level value exceeding a predetermined value among the non-zero coefficients which are located at and before the last non-zero coefficient in the reverse order of the scan order. In the case where a context is determined as above based on the number of non-zero coefficients each of which has a level value exceeding a predetermined value, the symbol occurrence probability is largely influenced by the position of the non-zero coefficient which is read first in the reverse order of the scan order (that is, the position of the last non-zero coefficient position in the scan order). Accordingly, when a context is determined based on a combination of the position of the last non-zero coefficient in the scan order and the number of non-zero coefficients each of which has a level value exceeding a predetermined value, the arithmetic coding can be performed using more appropriate probability information, which allows improvement in the coding efficiency.

In order to achieve the above object, an image coding apparatus according to an aspect of the present invention is an image coding apparatus which compresses and codes image data, the apparatus comprising: a binarization unit configured to binarize a plurality of coefficients to generate a binary signal, the plurality of coefficients being included in a unit of processing in a frequency domain obtained by frequency-transforming the image data; a context control unit configured to (i) determine a context to be used for arithmetic coding of the plurality of coefficients, based on a position of a last non-zero coefficient in a scan order among one or more non-zero coefficients included in the unit of processing and (ii) update, based on the binary signal, probability information corresponding to the determined context; and a binary arithmetic coding unit configured to perform arithmetic coding on the binary signal using the probability information corresponding to the determined context.

With this, the same or like effects as those in the above image coding method can be produced.

Furthermore, an image decoding method according to an aspect of the present invention is an image decoding method of decoding compressed and coded image data, the method comprising: determining a context to be used for arithmetic decoding of an input signal corresponding to a plurality of coefficients included in a unit of processing of the image data in a frequency domain, based on a position of a last non-zero coefficient in a scan order among one or more non-zero coefficients included in the unit of processing; performing arithmetic decoding on the input signal using probability information corresponding to the determined context, to generate a binary signal; updating, based on the binary signal, the probability information corresponding to the determined context; and reconstructing, using the binary signal, the plurality of coefficients included in the unit of processing.

With this, a context for arithmetic decoding of an input signal corresponding to a plurality of coefficients can be determined based on the position of the last non-zero coefficient in the scan order. Generally, with the last non-zero coefficient at a different position, the symbol occurrence frequency is often different in the binary signal obtained by binariziing the plurality of coefficients included in the unit of processing. By determining a context based on the position of the last non-zero coefficient, it is therefore possible to perform the arithmetic decoding on the input signal resulting from the arithmetic coding using more appropriate probability information. Thus, it is possible to appropriately decode the input signal coded with high coding efficiency.

Furthermore, in an image decoding method according to another aspect of the present invention, it is desirable that the position of the last non-zero coefficient be represented in a two-dimensional orthogonal coordinate system, and in the determining, the context be determined based on at least one of two coordinate values that indicate the position of the last non-zero coefficient.

With this, a context can be easily determined using coordinate-values in the case where the position of the last non-zero coefficient is represented in the two-dimensional orthogonal coordinate system.

Furthermore, in an image decoding method according to another aspect of the present invention, it is desirable that in the determining, the context be determined based on a sum of the two coordinate values.

With this, a context can be determined based on a sum of the coordinate values. This means that a context can be appropriately determined based on the magnitude of the frequency component which corresponds to the position of the last non-zero coefficient.

Furthermore, in an image decoding method according to another aspect of the present invention, it is desirable that in the determining, the context be determined based only on a larger one of the two coordinate values.

With this, a context can be determined based on the maximum value of the coordinate values. This means that a context can be appropriately determined based on the magnitude of the high-frequency component included in the frequency component which corresponds to the position of the last non-zero coefficient.

Furthermore, in an image decoding method according to another aspect of the present invention, it is desirable that the input signal include, in a reverse order of the scan order, a signal corresponding to a level which indicates a magnitude of each of the one or more non-zero coefficients included in the unit of processing, and in the determining, for each of the one or more non-zero coefficients included in the unit of processing, a context for arithmetic decoding of an input signal corresponding to the non-zero coefficient be determined based on the position of the last non-zero coefficient and the number of non-zero coefficients each of which has a level value exceeding a predetermined value among one or more non-zero coefficients located at and before the non-zero coefficient in the reverse order of the scan order.

With this, a context can be determined based on not only the position of the last non-zero coefficient in the scan order, but also the number of non-zero coefficients each of which has a level value exceeding a predetermined value among the non-zero coefficients which are located at and before the last non-zero coefficient in the reverse order of the scan order. In the case where a context is determined as above based on the number of non-zero coefficients each of which has a level value exceeding a predetermined value, the symbol occurrence probability is largely influenced by the position of the non-zero coefficient which is read first in the reverse order of the scan order (that is, the position of the last non-zero coefficient position in the scan order). Accordingly, when a context is determined based on a combination of the position of the last non-zero coefficient in the scan order and the number of non-zero coefficients each of which has a level value exceeding a predetermined value, the arithmetic decoding can be performed on the input signal resulting from the arithmetic coding using more appropriate probability information. Thus, it is possible to appropriately decode the input signal coded with high coding efficiency.

In order to achieve the above object, an image decoding apparatus according to an aspect of the present invention is an image decoding apparatus which decodes compressed and coded image data, the apparatus comprising: a context control unit configured to (i) determine a context to be used for arithmetic decoding of an input signal corresponding to a plurality of coefficients included in a unit of processing of the image data in a frequency domain, based on a position of a last non-zero coefficient in a scan order among one or more non-zero coefficients included in the unit of processing and (ii) update, based on a binary signal, probability information corresponding to the determined context; a binary arithmetic decoding unit configured to perform arithmetic decoding on the input signal using the probability information corresponding to the determined context, to generate the binary signal; and a coefficient reconstruction unit configured to reconstruct, using the binary signal, the plurality of coefficients included in the unit of processing.

With this, the same or like effects as those in the above image decoding method can be produced.

Furthermore, an image coding and decoding apparatus according to an aspect of the present invention comprises the above image coding apparatus and the above image decoding apparatus.

With this, the same or like effects as those in the above image coding method and in the above image decoding method can be produced.

Embodiments of the present invention are described below with reference to the drawings. It is to be noted that each of Embodiments described below illustrates one desirable specific example of the present invention. Numeric values, shapes, materials, constituents, positions and topologies of the constituents, steps, an order of the steps, and the like in the following Embodiments are an example of the present invention, and it should therefore not be construed that the present invention is limited to each of these Embodiments. Furthermore, out of the constituents in the following Embodiments, the constituents not stated in the independent claims describing the broadest concept of the present invention are described as given constituents in a more desirable embodiment.

### Embodiment 1

An outline of an image coding method according to Embodiment 1 of the present invention is described. In the arithmetic coding method according to this embodiment, when arithmetic coding is performed on a plurality of coefficients included in a unit of processing (block) in a frequency domain, a context for arithmetic coding of the plurality of coefficients is determined based on end position information indicating the position (the end position) of the last non-zero coefficient in the scan order. Using a symbol occurrence probability which corresponds to the context determined as above, the arithmetic coding is performed on the plurality of coefficients. With this, the symbol occurrence probability based on statistical information can be used, which allows improvement in the coding efficiency. Moreover, it is possible to appropriately set the number of contexts and thereby possible to appropriately set the number of symbol occurrence probabilities to be held, so that a memory size at the time of implementation can be reduced.

Furthermore, it is possible to appropriately use the symbol occurrence probability also in arithmetic coding of the end position information, which allows improvement in the coding efficiency.

The above is a description about the outline of the arithmetic coding method according to this embodiment.

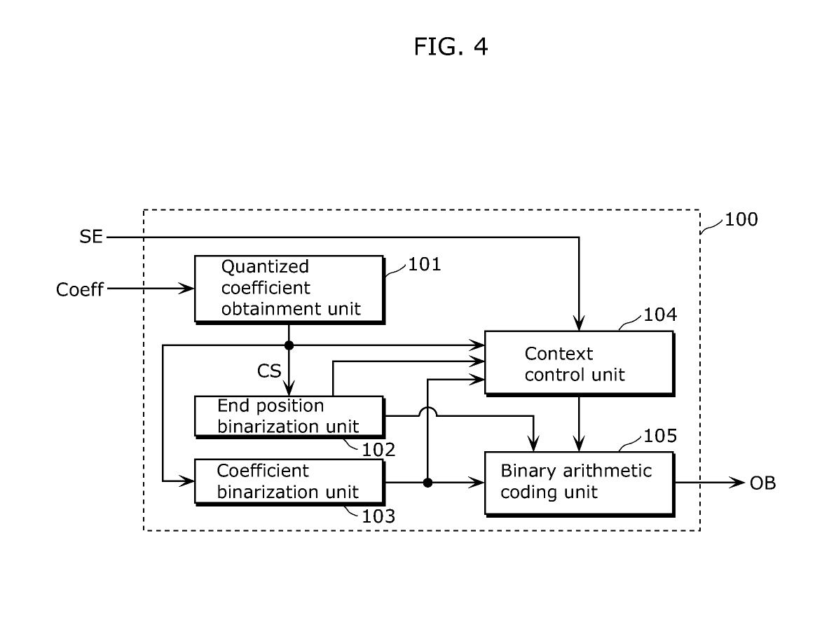

Next, a structure of an arithmetic coding unit according to this embodiment is described. FIG. 4 is a block diagram showing an example of a structure of an arithmetic coding unit 100 according to Embodiment 1 of the present invention. As will be described below, the arithmetic coding unit 100 according to Embodiment 1 of the present invention corresponds to a part of an image coding apparatus which compresses and codes image data.

As shown in FIG. 4, the arithmetic coding unit 100 includes a quantized coefficient obtainment unit 101, an end position binarization unit 102, a coefficient binarization unit 103, a context control unit 104, and a binary arithmetic coding unit 105.

The arithmetic coding unit 100 performs arithmetic decoding on a coefficient signal Coeff which is to be coded, and thereby generates and outputs an output signal OB. Furthermore, the arithmetic coding unit 100 receives signal information SE which corresponds to the coefficient signal Coeff.

The quantized coefficient obtainment unit 101 obtains the coefficient signal Coeff and outputs a coefficient-related signal CS to the end position binarization unit 102 and the context control unit 104.

The end position binarization unit 102 binarizes, based on the obtained coefficient-related signal CS, position information (end position information) on the last non-zero coefficient in the predetermined order (scan order). The end position binarization unit 102 outputs the binarized end position information (a binary signal corresponding to the end position information) to the binary arithmetic coding unit 105.

Here, the end position indicates a position of the non-zero coefficient which is last in the scan order among the non-zero coefficients included in the coefficient signal Coeff. In other words, the end position is a position of the non-zero coefficient which is read last in a predetermined order in which the plurality of coefficients included in the coefficient signal Coeff are read.

A method of binarizing the end position information will be described in detail later.

The coefficient binarization uit 103 binarizes the plurality of coefficients included in the coefficient signal Coeff. Specifically, the coefficient binarization unit 103 reads the plurality of coefficients in a predetermined scan order and outputs, as a binary signal, information (Significantflag) indicating whether the read coefficient is a zero coefficient or a non-zero coefficient.

Furthermore, when the read coefficient is a non-zero coefficient, the coefficient binarization unit 103 binarizes information (Level) indicating the magnitude of the read non-zero coefficient and outputs the information as a binary signal. In addition, when the read coefficient is a non-zero coefficient, the coefficient binarization unit 103 outputs, as a binary signal, information (Sign) indicating plus and minus of the read non-zero coefficient.

The context control unit 104 determines, based on the signal information SE and the coefficient-related signal CS, a context for arithmetic coding of the binary signals outputted from the end position binarization unit 102 and the coefficient binarization unit 103. The context control unit 104 then outputs, to the binary arithmetic coding unit 105, the symbol occurrence probability which corresponds to the determined context.

Here, the symbol occurrence probability indicates probability information to be used in the arithmetic coding of the binary signal. Specifically, the probability information is an index indicating a value of the symbol occurrence probability or is a value of the symbol occurrence probability, for example.

Furthermore, a plurality of symbol occurrence probabilities are stored in a memory (not shown) included in the context control unit 104. The context control unit 104 refers, for example, to a symbol occurrence probability table to specify, among the plurality of symbol occurrence probabilities stored in the memory, a symbol occurrence probability which corresponds to the context. The symbol occurrence probability table is a table in which contexts and probability information are associated. Details of the symbol occurrence probability table and determination of a context will be described later.

Using the symbol occurrence probability obtained from the context control unit 104, the binary arithmetic coding unit 105 performs the arithmetic coding on the binary signals obtained from the end position binarization unit 102 and the coefficient binarization unit 103.

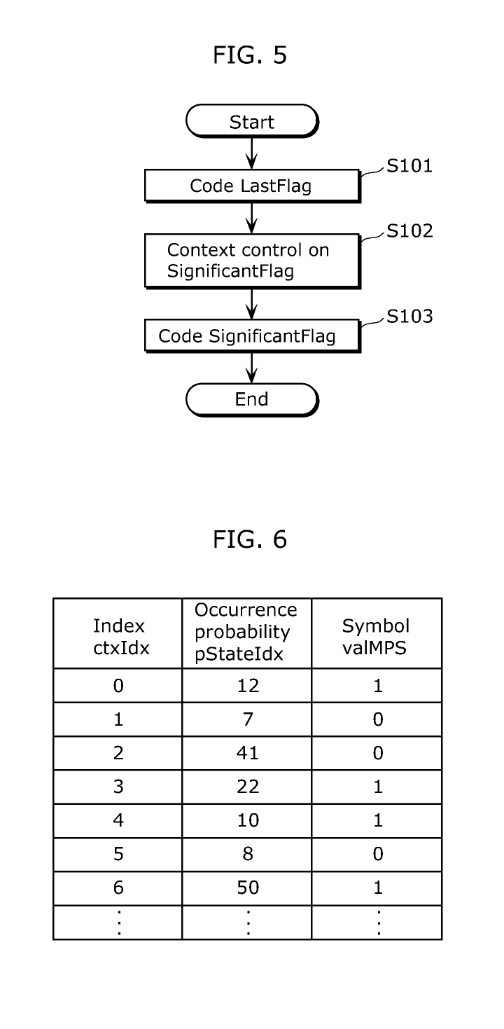

Next, an operation of the arithmetic coding unit 100 configured as above is described with reference to FIG. 5. FIG. 5 is a flowchart showing an example of processing operation of the arithmetic coding unit 100 according to Embodiment 1 of the present invention.

First, the binary arithmetic coding unit 105 performs, using the symbol occurrence probability, the arithmetic coding on the binary signal corresponding to the end position information obtained from the end position binarization unit 102 (Step S101). The binary arithmetic coding unit 105 then outputs the result of arithmetic coding as the output signal OB.

Next, the coefficient binarization unit 103 obtains the coefficient-related signal CS. The coefficient binarization unit 103 then reads, in a predetermined order (scan order), the plurality of quantized coefficients indicated by the obtained coefficient-related signal CS and outputs, as a binary signal, information (SignificantFlag) indicating whether the read coefficient is a zero coefficient or a non-zero coefficient (for example, binary data (symbol) indicating 1 for a non-zero coefficient and 0 for a zero coefficient).

From the signal information SE and the coefficient-related signal CS, the context control unit 104 determines, based on the end position information, a context for arithmetic coding of SignificantFlag (Step S102). In short, the context control unit 104 determines, based on the end position, a context for arithmetic coding of a coefficient. The context control unit 104 then outputs, to the binary arithmetic coding unit 105, the symbol occurrence probability which corresponds to the determined context. A detail of determination of a context will be described later.

The binary arithmetic coding unit 105 performs, using the symbol occurrence probability obtained from the context control unit 104, the arithmetic coding on SignificantFlag (the binary signal) obtained from the coefficient binarization unit 103 (Step S103). The binary arithmetic coding unit 105 then outputs the result of arithmetic coding as the output signal OB.

Here, the symbol occurrence probability table held by the context control unit 104 is described. FIG. 6 shows an example of the symbol occurrence probability table according to Embodiment 1 of the present invention.

The symbol occurrence probability table is a table in which contexts and symbol occurrence probabilities are associated. A context index (ctxIdx) in FIG. 6 is an index indicating a context. Specifically, the context index is an index which is determined according to peripheral information on a macroblock being coded, already-coded information on the block, or a bit position of a binary signal to be coded.

An entry indicated by each index includes probability information (pStateIdx) indicating the symbol occurrence probability and a symbol (vaIMPS) indicating a symbol having a high occurrence probability (Most Probable Symbol). The entry is equivalent to the entry specified in the H.264 standard. Specifically, pStateIdx is an index indicating a value of the symbol occurrence probability. The context control unit 104 further holds a table indicating a value of the symbol occurrence probability which corresponds to pStateIdx.

Although the symbol occurrence probability is managed here using a table in which the index (pStateIdx) indicating the symbol occurrence probability is associated with the context (ctxIdx), the symbol occurrence probability may be managed through direct association between the context and a value of the symbol occurrence probability. In this case, the value of the symbol occurrence probability is expressed with, for example, 16-bit accuracy (0-65535), which makes it possible to deal with more detailed values than in the management using the above table.

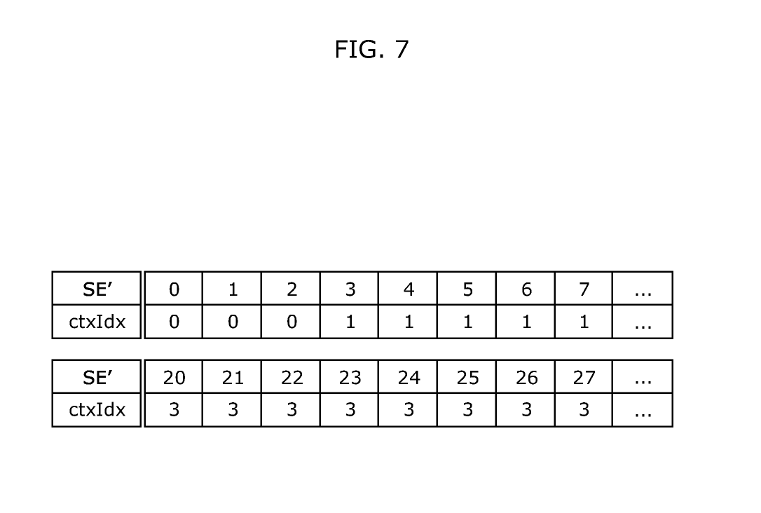

Next, the context table held by the context control unit 104 is described. FIG. 7 shows an example of the context table according to Embodiment 1 of the present invention.

The context table is a table in which a plurality of types and contexts are associated. In the context table shown in FIG. 7, the context indices are associated with types SE′ obtained by adding conditions to the signal type information SE. With reference to this context table, the context control unit 104 determines a context.

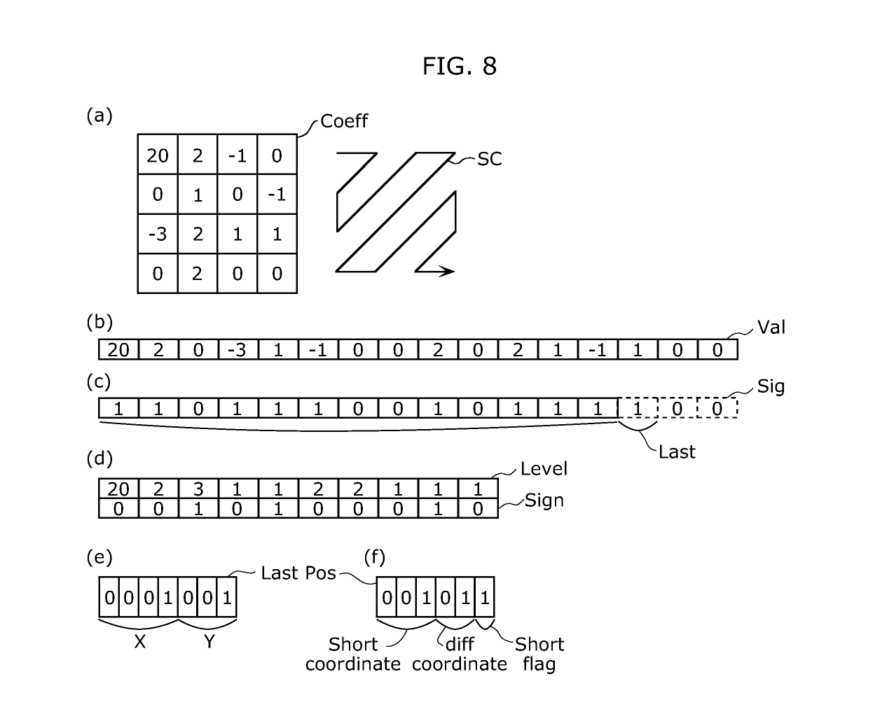

Next, a binarization method according to this embodiment is described. FIG. 8 schematically illustrates an example of the binarization method according to Embodiment 1 of the present invention.

FIG. 8 shows, in (a), an example of the coefficient Coeff and the scan order SC. As shown in (a) of FIG. 8, the coefficient signal Coeff indicates a unit of processing, in a frequency domain, obtained by frequency-transforming image data. Here, in the unit of processing, coefficients are arranged in a matrix according to frequency components. When coefficients included in a unit of processing are quantized coefficients, the unit of processing is referred to also as a quantized coefficient value group.

As shown in (a) of FIG. 8, the scan order SC is a predetermined order for reading a plurality of coefficients. Here, as an example of the scan order SC, a zigzag order is shown.

FIG. 8 shows, in (b), a coefficient sequence (Val) obtained by reading, in the scan order SC, all the coefficients included in the unit of processing shown in (a) of FIG. 8. Furthermore, FIG. 8 shows, in (c), a signal (Sig) composed of arranged pieces of information (SignificantFlag) indicating whether each coefficient included in the coefficient sequence is a zero coefficient or a non-zero coefficient.

Since the end position information is first coded in this embodiment, SignificantFlag at the end position (the position denoted by Last) is not required to be coded. Specifically, in (c) of FIG. 8, the arithmetic coding is performed on the binary signal from the leftmost symbol to the symbol located on the left next to the symbol at the end position. This makes it possible to reduce binary data for one bit, which allows improvement in the coding efficiency.

FIG. 8 shows, in (d), information (Level) indicating the magnitude of a non-zero coefficient and information (Sign) indicating plus and minus of a non-zero coefficient. Here, as an example of Sign, plus (+) is represented as “0” while minus (−) is represented as “1”.

Here, since SignificantFlag has already shown that the coefficient is non-zero, it is sufficient that a value obtained by subtracting 1 from the value shown in (d) of FIG. 8 is binarized and coded in the coding of Level.

Furthermore, in the arithmetic coding of Level, Level may be read from the end position in the reverse order of the scan order. In this case, every time the level value exceeds a predetermined value, the context for arithmetic coding may be changed.

This means that the coefficient binarization unit 103 may generate the binary signal by binarizing Level in the reverse order of the scan order. In this case, the context control unit 104 may determine, for each non-zero coefficient, a context for arithmetic coding of Level of the non-zero coefficient, based on the position of the last non-zero coefficient and the number of non-zero coefficients each of which has Level exceeding a predetermined value among the non-zero coefficients located at and before the non-zero coefficient in the reverse order of the scan order.

By changing the context every time the magnitude of the coefficient value exceeds a predetermined magnitude as above, the arithmetic coding unit 100 is capable of performing the arithmetic coding on Level using an appropriate context, which allows improvement in the coding efficiency. At this time, determination of a context also based on the position of the last non-zero coefficient will allow the context to be appropriately determined based on distribution of the non-zero coefficients, with the result that the coding efficiency can be further improved.

FIG. 8 shows, in each of (e) and (f), an example of binarization of the end position information (LastPos). In (a) of FIG. 8, the end position is located at the coordinates (3, 2) in a two-dimensional orthogonal coordinate system where the position of a direct-current component is represented as the origin (0, 0).

In the binarization method shown in (e) of FIG. 8, the x-coordinate value and the y-coordinate value which indicate the end position are binarized. Here, the x-coordinate value “3” is binarized into “0001” and the y-coordinate value “2” is binarized into “001”. It is to be noted that the x-coordinate value and the y-coordinate value do not always need to be binarized in this way. For example, it may be possible that the x-coordinate value “3” is binarized into “1110” and the y-coordinate value “2” is binarized into “110”.

In another binarization method shown in (f) of FIG. 8, a value on a short coordinate is binarized first. The short coordinate indicates one of the x-coordinate and the y-coordinate indicating the end position, whose code length after binarization is shorter. The coordinate other than the short coordinate is referred to as a long coordinate. When the x-coordinate and the y-coordinate have the same value, either coordinate may be the short coordinate.

Next, a difference between the x-coordinate and the y-coordinate is binarized. This difference is hereinafter referred to as a difference coordinate (diff coordinate).

Lastly, a short-coordinate flag (short flag) is added which is information indicating which one of the x-coordinate and the y-coordinate is the short-coordinate.

As shown in (f) of FIG. 8, binarization of the short-coordinate value allows the code length of the binary signal to be shorter than that obtained by binarization of the long-coordinate value. Furthermore, the possible value range of the difference coordinate value which is to be coded immediately following the short-coordinate value is limited by the already-coded short-coordinate value. For example, when the short-coordinate value is small, the difference coordinate value can be large, while, when the short-coordinate value is large, the difference coordinate value can only be small, which narrows the possible value range. Thus, by using the short-coordinate value in a later-described context control for the difference coordinate value, the context control unit 104 is capable of appropriately determining a context for the difference coordinate value. As above, the arithmetic coding is performed on the difference coordinate value instead of the long-coordinate value, which allows improvement in the coding efficiency.

Furthermore, coding of the above-described difference coordinate value before cording of the short-coordinate flag allows coding of the short-coordinate flag to be omitted when the difference coordinate value is zero, for example. Accordingly, the code length of the binary signal can be reduced, with the result that the coding efficiency can be improved.

Here, a more detailed explanation is given on a specific example of binarization of various types of the end position information in the binarization methods shown in (e) and (f) of FIG. 8.

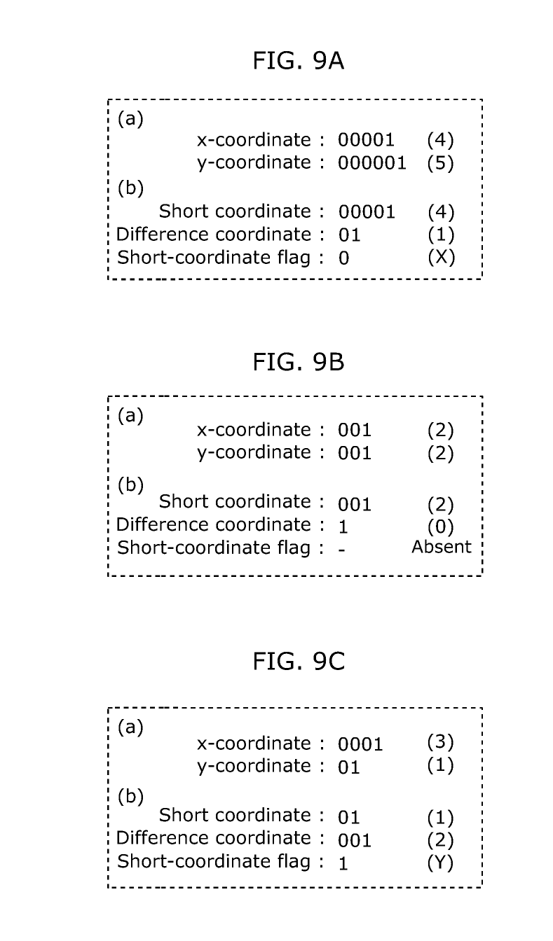

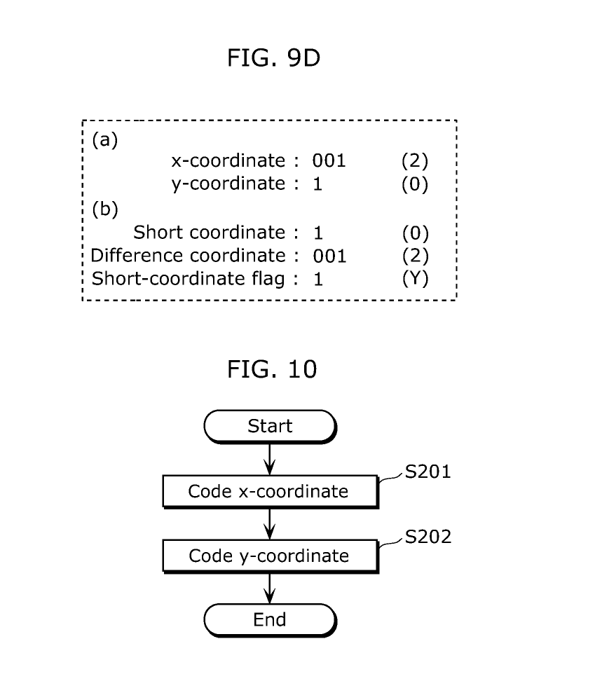

FIGS. 9A to 9D each show an example of a binarization result of the end position information according to Embodiment 1 of the present invention. Hereinafter, the binarization method in (e) of FIG. 8 is referred to as a first binarization method, and the binarization method in (f) of FIG. 8 is referred to as a second binarization method. In each of FIGS. 9A to 9D, (a) shows a result of binarization in the first binarization method, and (b) shows a result of binarization in the second binarization method.

FIG. 9A shows an example of a binarization result in the case where the end position is located at the coordinates (4, 5). In this case, the code length of the binary signal becomes “11” in (e). Meanwhile, the code length of the binary signal becomes “8” in (b). This is because, in the case of FIG. 9A, the sum of the code length of the difference value and the code length of the short-coordinate flag is less than the code length of the long-coordinate value.

FIG. 9B shows an example of a binarization result in the case where the end position is located at the coordinates (2, 2). In this case, the code length of the binary signal becomes “6” in (a). Meanwhile, the code length of the binary signal becomes “4” in (b) because the short-coordinate flag is unnecessary.

FIG. 9C shows an example of a binarization result in the case where the end position is located at the coordinates (3, 1). In this case, the code length of the binary signal becomes “6” in (a). Furthermore, the code length of the binary signal becomes “6” in (b). Thus, the binary signal in (a) and the binary signal in (b) have the same code length. Even in this case, the second binarization method can improve the coding efficiency more than the first binarization method can improve, owing to a later-described context control.

FIG. 9D shows an example of a binarization result in the case where the end position is located at the coordinates (2, 0). In this case, the code length of the binary signal becomes “4” in (a) while the code length of the binary signal becomes “5” in (b). Thus, the code length in the second binarization method is greater than that in the first binarization method. This occurs only when one of the coordinate values is “0”. Even in this case, the second binarization method can improve the coding efficiency more than the first binarization method can improve, owing to the later-described context control.

Next, a procedure of coding the end position information is described. First, a description is given of a coding method applied in the case where the end position information has been binarized by the above-described first binarization method.

FIG. 10 is a flowchart showing an example of the arithmetic coding method for the end position information according to Embodiment 1 of the present invention.

First, the binary arithmetic coding unit 105 performs arithmetic coding on the binary signal corresponding to the x-coordinate, using the symbol occurrence probability output from the context control unit 104 (Step S201). In this case, the context control unit 104 determines a context for arithmetic coding of the binary signal corresponding to the x-coordinate and outputs, to the binary arithmetic coding unit 105, the symbol occurrence probability obtained from the probability information which corresponds to the determined context.

Next, as in the case of the x-coordinate, the binary arithmetic coding unit 105 performs arithmetic coding on the binary signal corresponding to the y-coordinate, using the symbol occurrence probability output from the context control unit 104 (Step S202). Also in this case, the context control unit 104 determines a context for arithmetic coding of the binary signal corresponding to the y-coordinate and outputs, to the binary arithmetic coding unit 105, the symbol occurrence probability obtained from the probability information which corresponds to the determined context, as in the case of the x-coordinate.

Here, the determination of a context in Steps S201 and S202 is described in detail.

For example, in the case where the arithmetic coding is performed, in sequence from the left, on the symbols included in the binary signal, the context control unit 104 determines a context based on a place in the order (the bit position) of each symbol. At this time, the context control unit 104 may determine a context based on the bit position, from a context set corresponding to the size of a processing target block, for example. Here, the context set indicates a set of contexts including at least one context.

This means that the context control unit 104 may determine mutually different contexts for symbols which are located at the same bit position but correspond to different block sizes. In this case, the context control unit 104 does not always need to determine a context for the symbol at every bit position in this way.

For example, even when the block sizes are different, the context control unit 104 may determine the same context for the symbols at the bit positions which are located after a predetermined place in the order, as long as the symbols are located at the same bit position. In other words, the context control unit 104 determines, per block size, different contexts for the symbols at the bit positions which are located at and before the predetermined place in the order, and determines a context common to a plurality of block sizes, for the symbols at the bit positions which are located after the predetermined place in the order. In this case, the number of contexts can be reduced more than that in the case where a different context is determined, per block size, for the symbol at every bit position, with the result that the reduction of memory capacity for holding the probability information and the like can be achieved.

It may also be possible that, for example, the context control unit 104 determines, per bit position, different contexts for the symbols at the bit positions which are located at and before a predetermined place (for example, the second place) in the order from the leftmost symbol, and determines the same context for the symbols at the bit positions which are located after the predetermined number of symbols. In this case, the number of contexts can be reduced as compared to the case where mutually different contexts are assigned to all the bit positions, with the result that the reduction of memory capacity for holding the probability information and the like can be achieved.

Furthermore, for example, for the symbols at the bit positions which are located after a predetermined number of symbols (for example, ten symbols) from the leftmost symbol, the context control unit 104 may not determine contexts and may output a fixed symbol occurrence probability (for example, 50%) to the binary arithmetic coding unit 105.

In addition, the context control unit 104 may use a method different from the method for the x-coordinate, to determine a context for arithmetic coding of the binary signal corresponding to the y-coordinate. For example, the context control unit 104 may determine, based on the already-coded x-coordinate value, a context for arithmetic coding of the binary signal corresponding to the y-coordinate. Specifically, the context control unit 104 may determine a context for coding of the y-coordinate value, according to a level (for example, low, medium, and high) corresponding to the x-coordinate value, for example.

With this, the correlation between the x-coordinate value and the y-coordinate value can be used to determine a context. Generally, the correlation between the y-coordinate value and the x-coordinate value is often high. For example, when the x-coordinate value is small, the y-coordinate value is often small as well, while, when the x-coordinate value is large, the y-coordinate value is often large as well. The determination of a context using such correlation between the x-coordinate value and the y-coordinate value allows elaborated derivation of the symbol occurrence probability and thereby allows improvement in the coding efficiency.

Furthermore, the method of determining a context for arithmetic coding of the binary signal corresponding to the x-coordinate value or the y-coordinate is not limited to the above-described method. For example, based on a symbol included in the binary signal corresponding to one of the x-coordinate and the y-coordinate, the context control unit 104 may determine a context for the binary signal corresponding to the other of the x-coordinate and the y-coordinate.

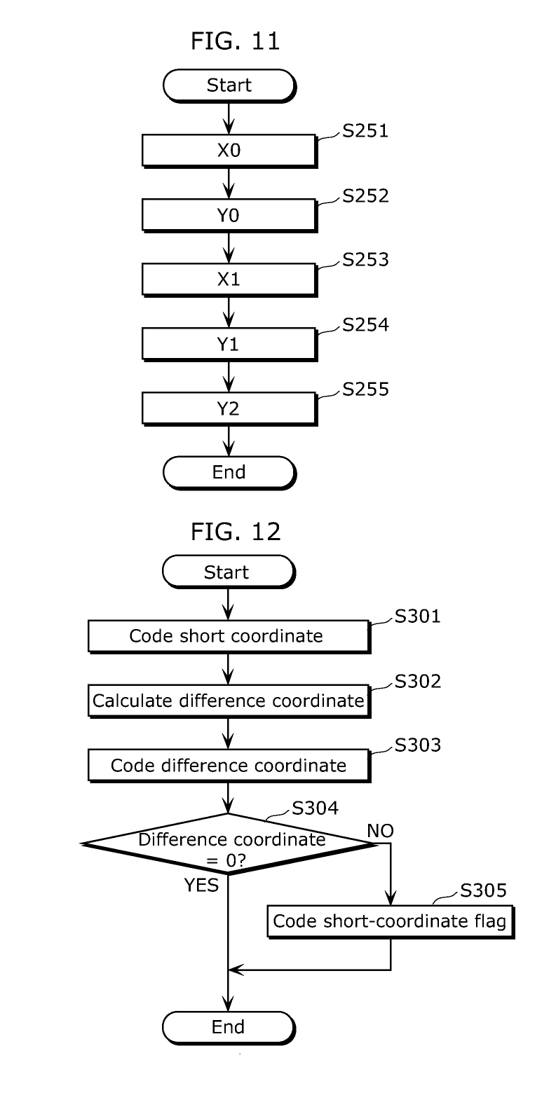

Specifically, for example, the context control unit 104 may determine, based on a value of the symbol located first from the left in the binary signal corresponding to the x-coordinate, a context for the symbol located first from the left in the binary signal corresponding to the y-coordinate. Furthermore, the context control unit 104 may determine, based on a value of the symbol located first from the left in the binary signal corresponding to the y-coordinate, a context for the symbol located second from the left in the binary signal corresponding to the x-coordinate. A flow of such processing of performing arithmetic coding alternately on a symbol included in the binary signal corresponding to the x-coordinate and on a symbol included in the binary signal corresponding to the y-coordinate is described with reference to FIG. 11.

FIG. 11 is a flowchart showing an example of the arithmetic coding method for the end position information according to Embodiment 1 of the present invention. Here, the case where the end position information is (1, 2) is described as an example. In the case where the end position information is (1, 2), the binary signal corresponding to the x-coordinate is “01” and the binary signal corresponding to the y-coordinate is “001”.

First, the context control unit 104 determines a context for the symbol located first in the binary signal corresponding to the x-coordinate and outputs, to the binary arithmetic coding unit 105, the symbol occurrence probability which corresponds to the determined context. The binary arithmetic coding unit 105 then performs, using the symbol occurrence probability obtained from the context control unit 104, the arithmetic coding on the symbol located first in the binary signal corresponding to the x-coordinate (Step S251). On the basis of the symbol located first in the binary signal corresponding to the x-coordinate, the context control unit 104 updates the symbol occurrence probability which corresponds to the determined context.

Next, on the basis of the symbol located first in the binary signal corresponding to the x-coordinate, the context control unit 104 determines a context for the symbol located first in the binary signal corresponding to the y-coordinate and outputs, to the binary arithmetic coding unit 105, the symbol occurrence probability which corresponds to the determined context. The binary arithmetic coding unit 105 then performs, using the symbol occurrence probability obtained from the context control unit 104, the arithmetic coding on the symbol located first in the binary signal corresponding to the y-coordinate (Step S252). Furthermore, on the basis of the symbol located first in the binary signal corresponding to the y-coordinate, the context control unit 104 updates the symbol occurrence probability which corresponds to the determined context.

Specifically, since the symbol located first in the binary signal corresponding to the x-coordinate is “0”, the context control unit 104 selects, as a context for the symbol located first in the binary signal corresponding to the y-coordinate, one context “CTX-0” from among a plurality of predetermined contexts. For example, when the symbol located first in the binary signal on the x-coordinate is “1”, the context control unit 104 selects, as the context for the symbol located first in the binary signal corresponding to the y-coordinate, another context “CTX-1” from among the plurality of predetermined contexts.

Next, on the basis of the symbol located first in the binary signal corresponding to the y-coordinate, the context control unit 104 determines a context for the symbol located second from the left in the binary signal corresponding to the x-coordinate and outputs, to the binary arithmetic coding unit 105, the symbol occurrence probability which corresponds to the determined context. The binary arithmetic coding unit 105 then performs, using the symbol occurrence probability obtained from the context control unit 104, the arithmetic coding on the symbol located second from the left in the binary signal corresponding to the x-coordinate (Step S253). On the basis of the symbol located second from the left in the binary signal corresponding to the x-coordinate, the context control unit 104 updates the symbol occurrence probability which corresponds to the determined context.

Next, on the basis of the symbol located second from the left in the binary signal corresponding to the x-coordinate, the context control unit 104 determines a context for the symbol located second from the left in the binary signal corresponding to the y-coordinate and outputs, to the binary arithmetic coding unit 105, the symbol occurrence probability which corresponds to the determined context. The binary arithmetic coding unit 105 then performs, using the symbol occurrence probability obtained from the context control unit 104, the arithmetic coding on the symbol located second from the left in the binary signal corresponding to the y-coordinate (Step S254). Furthermore, on the basis of the symbol located second from the left in the binary signal corresponding to the y-coordinate, the context control unit 104 updates the symbol occurrence probability which corresponds to the determined context.

Here, the coding of the binary signal corresponding to the x-coordinate has already been completed. Thus, based on information indicating absence of the symbol located third from the left in the binary signal corresponding to the x-coordinate, the context control unit 104 determines a context for the symbol located third from the left in the binary signal corresponding to the y-coordinate and outputs, to the binary arithmetic coding unit 105, the symbol occurrence probability which corresponds to the determined context. The binary arithmetic coding unit 105 then performs, using the symbol occurrence probability obtained from the context control unit 104, the arithmetic coding on the symbol located third from the left in the binary signal corresponding to the y-coordinate (Step S255). Furthermore, on the basis of the symbol located third from the left in the binary signal corresponding to the y-coordinate, the context control unit 104 updates the symbol occurrence probability which corresponds to the determined context.

It is to be noted that although a context for a coding target symbol is changed based on a symbol on which the arithmetic coding has been performed immediately before the coding target symbol in FIG. 11, the method of determining a context is not limited to the above method. For example, the context control unit 104 may change a context based only on the symbol located first in the binary signal corresponding to the x-coordinate from among the plurality of symbols included in the binary signal. Furthermore, a context may be changed based on the symbol located first in the binary signal corresponding to each of the x-coordinate and the y-coordinate. With this, as compared to the case of changing a context based on each symbol, the processing for changing a context can be reduced, which allows a reduction in the circuit size.

Next, a description is given of a coding method applied in the case where the end position information has been binarized by the above-described second binarization method.

FIG. 12 is a flowchart showing another example of the arithmetic coding method for the end position information according to Embodiment 1 of the present invention.

First, the binary arithmetic coding unit 105 performs arithmetic coding on the binary signal corresponding to the short coordinate, using the symbol occurrence probability output from the context control unit 104 (Step S301). In this case, the context control unit 104 determines a context for arithmetic coding of the binary signal corresponding to the short coordinate and outputs, to the binary arithmetic coding unit 105, the symbol occurrence probability obtained from the probability information which corresponds to the determined context.

For example, in the case where the arithmetic coding is performed, in sequence from the left, on the symbols included in the binary signal, the context control unit 104 determines a context based on a place in the order (the bit position) of each symbol. Furthermore, the context control unit 104 may determine a context based not only on the bit position, but also on the size of a processing target block, for example. This means that the context control unit 104 may determine a context so that when the block size is different, the context is also different even for the same bit position.

It may also be possible that, for example, the context control unit 104 determines, per bit position, different contexts for the symbols at the bit positions which are located at and before a predetermined number of symbols (for example, two symbols) from the leftmost symbol, and determines the same context for the symbols at the bit positions which are located after the predetermined number of symbols. In this case, the number of contexts can be reduced as compared to the case where mutually different contexts are assigned to all the bit positions, with the result that the reduction of memory capacity for holding the probability information and the like can be achieved.

Furthermore, for example, for the symbols at the bit positions which are located after a predetermined number of symbols (for example, ten symbols) from the leftmost symbol, the context control unit 104 may not determine contexts and may output a fixed symbol occurrence probability (for example, 50%) to the binary arithmetic coding unit 105.

Next, the end position binarization unit 102 calculates the difference coordinate value by subtracting the short-coordinate value from the long-coordinate value (Step S302). The end position binarization unit 102 then binarizes the difference coordinate value to generate the binary signal corresponding to the difference coordinate value. The generated binary signal is output to the context control unit 104 and the binary arithmetic coding unit 105.

Next, the binary arithmetic coding unit 105 performs arithmetic coding on the binary signal corresponding to the difference coordinate value, using the symbol occurrence probability output from the context control unit 104 (Step S303). In this case, the context control unit 104 determines a context for arithmetic coding of the binary signal corresponding to the difference coordinate and outputs, to the binary arithmetic coding unit 105, the symbol occurrence probability obtained from the probability information which corresponds to the determined context.

For example, in the case where the arithmetic coding is performed, in sequence from the left, on the symbols included in the binary signal, the context control unit 104 determines a context based on a place in the order (the bit position) of each symbol, as in the above-described case of coding the short-coordinate value. Furthermore, the context control unit 104 may determine a context based not only on the bit position, but also on the size of a processing target block, for example. This means that the context control unit 104 may determine a context so that when the block size is different, the context is also different even for the same bit position.

In addition, since the arithmetic coding is performed on the difference coordinate value, the context control unit 104 may determine, as a context for the difference coordinate value, a context common to a part of a plurality of block sizes. For example, the context may be common to the 16×16 block size and the 32×32 block size. In this case, the number of contexts can be reduced as compared to the case where mutually different contexts are assigned to all the block sizes, with the result that the reduction of memory capacity for holding the probability information and the like can be achieved.

It may also be possible that, for example, the context control unit 104 determines, per bit position, different contexts for the symbols at the bit positions which are located at and before a predetermined number of symbols (for example, two symbols) from the leftmost symbol, and determines the same context for the symbols at the bit positions which are located after the predetermined number of symbols. In this case, the number of contexts can be reduced as compared to the case where mutually different contexts are assigned to all the bit positions, with the result that the reduction of memory capacity for holding the probability information and the like can be achieved.

Furthermore, for example, for the symbols at the bit positions which are located after a predetermined number of symbols (for example, ten symbols) from the leftmost symbol, the context control unit 104 may not determine contexts and may output a fixed symbol occurrence probability (for example, 50%) to the binary arithmetic coding unit 105.

Furthermore, the context control unit 104 may determine a context for the difference coordinate value based on the already-coded short-coordinate value. For example, when the short-coordinate value is a predetermined value (for example, “3”) or less, there is a possibility that the difference coordinate value becomes large. On the other hand, when the short-coordinate value is a predetermined value (for example, “10”) or more, it is highly likely that the difference coordinate value becomes small. Accordingly, it is better to use a different context depending on the magnitude of the short-coordinate value to enable more appropriate prediction of the symbol occurrence probability. In addition, the threshold (predetermined value) in this case may be different depending on the block size. This is because the possible range of the coordinate value is different depending on the block size. With this, further improvement in the coding efficiency can be expected.

Here, when the difference coordinate value is “0” (YES in Step S304), there is no need to distinguish the short-coordinate value and the long-coordinate value, with the result that the coding process is brought to an end. On the other hand, when the difference coordinate value is not “0” (NO in Step S304), the binary arithmetic coding unit 105 performs binary arithmetic coding on information indicating which one of the x-coordinate and the y-coordinate has already been coded as the short-coordinate value, i.e., a short-coordinate flag (which is “0” for the x-coordinate and “1” for the y-coordinate, for example) (Step S305).

In this case, the context control unit 104 may determine a context for the short-coordinate flag so that the context is different for each block size, but the present invention is not limited to this example. For example, even with different block sizes, the tendencies of which one of the x-coordinate and the y-coordinate is the short coordinate are often the same when the tendencies of coefficients in the horizontal and vertical directions are the same. Thus, the context control unit 104 may determine a context for the short-coordinate flag so that the same context is determined for different block sizes. In this case, the number of contexts can be reduced as compared to the case where mutually different contexts are assigned to all the block sizes, with the result that the reduction of memory capacity for holding the probability information and the like can be achieved.

Furthermore, the context control unit 104 may determine a context for the short-coordinate flag so that a context is common to a part of a plurality of block sizes. For example, the context control unit 104 may determine a context for the short-coordinate flag so that the context for the 4×4 block and the context common to the blocks with a size other than 4×4 are different. The context control unit 104 may also change the context depending on the block size of three types, i.e, (4×4), (8×8), and (16×16 and 32×32). By determining a context as above, further improvement in the coding efficiency can be achieved.

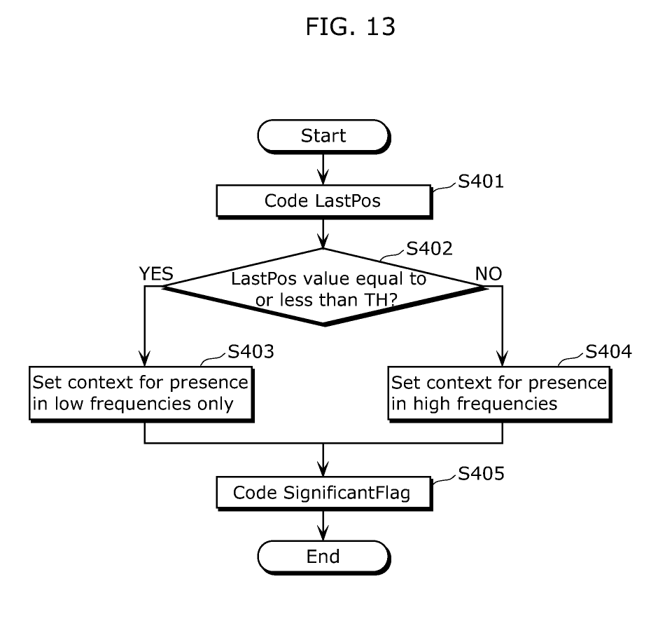

With reference to FIG. 13, the following describes in detail the processing applied in the case of performing the arithmetic coding on SignificantFlag which is an example of the coefficient information.

FIG. 13 is a flowchart showing an example of the arithmetic coding method for the coefficient information according to Embodiment 1 of the present invention.

First, the arithmetic coding unit 100 codes the end position information (LastPos) by the above-described method (Step S401). Next, when the value obtained from LastPos is equal to or less than a threshold TH (YES in Step S402), the context control unit 104 selects a context set specific to the case where there are non-zero coefficients only in a low-frequency region (Step S403).

On the other hand, when the value obtained from LastPos is greater than the threshold TH (NO in Step S402), the context control unit 104 selects a context set specific to the case where there are non-zero coefficients also in a high-frequency region (Step S404).

Next, the context control unit 104 determines, from the selected context set, a context for SignificantFlag, by a predetermined means. Using the symbol occurrence probability which corresponds to the determined context, the binary arithmetic coding unit 105 then performs the arithmetic coding on SignificantFlag (Step S405).

Here, in the case where LastPos is represented in a two-dimensional orthogonal coordinate system, the value obtained from LastPos is a value obtained from at least one of the two coordinate values that indicate LastPos. In other words, the context control unit 104 determines a context based on at least one of the two coordinate values that indicate the position of the last non-zero coefficient.

More specifically, the value obtained from LastPos is, for example, the sum of two coordinate values that indicate LastPos. In other words, the context control unit 104 determines a context based on the sum of two coordinate values. In this case, it is sufficient that the context control unit 104 compares (the x-coordinate value+the y-coordinate value) with the threshold TH in Step S402. By so doing, the context control unit 104 changes the context sets in such a way that, for example, when the threshold TH is “5”, a diagonal line passing through (0, 5), (1, 4), (2, 3), (3, 2), (4, 1), and (5, 0) is a boundary.

Alternatively, the value obtained from LastPos may be, for example, a larger one of the two coordinate values that indicate LastPos. In other words, the context control unit 104 may determine a context based only on the larger one of the two coordinate values. In this case, it is sufficient that the context control unit 104 compares MAX (the x-coordinate value, the y-coordinate value) with the threshold TH in Step S402. For example, when the threshold TH is “5”, the context control unit 104 changes the context sets in such a way that a straight line passing through (0, 5) and (5, 5) and a straight line passing through (5, 0) and (5, 5) are boundaries.

In addition, the value obtained from LastPos may be an arithmetic mean value or a geometrical mean value of the two coordinate values, for example.

Although there is one threshold TH here, there may be a plurality of thresholds TH. With the plurality of thresholds TH, it is possible to switch among three or more context sets based on LastPos. In this case, more detailed prediction of the symbol occurrence probabilities is possible, with the result that improvement in the coding efficiency can be expected.

Furthermore, in Step S405, it is sufficient that the binary arithmetic coding unit 105 performs, in the scan order, the arithmetic coding on the sequence of symbols located before the position denoted by Last in (c) of FIG. 8. The reason why no arithmetic coding is performed on SignificantFlag at the position denoted by Last is that LastPos shows that the coefficient at the position denoted by Last is a non-zero coefficient.

It is to be noted that, in Step S405, the context control unit 104 determines a context for arithmetic coding of SignificantFlag from the context set determined in Step S403 or Step S404. Specifically, the context control unit 104 determines a context based on the coefficient position of SignificantFlag, for example. Furthermore, for example, the context control unit 104 may determine a context based on the number of zero coefficients or non-zero coefficients which are adjacent to the processing target coefficient in the unit of processing in the frequency domain (hereinafter referred to simply as “adjacent zero coefficients” or “adjacent non-zero coefficients”).

Furthermore, for example, the context control unit 104 may determine a context based on both of the coefficient position and the number of adjacent zero coefficients or adjacent non-zero coefficients. More specifically, it may be possible, for example, that the context control unit 104 determines a context based on the coefficient position in the case of a low-frequency region while determining a context based on the number of adjacent zero coefficients or adjacent non-zero coefficients in the case of a high-frequency region.

Furthermore, the arithmetic coding unit 100 may perform the arithmetic coding on SignificantFlag in the reverse scan order from the end position. In this case, it is expected that the probability of occurrence of a non-zero coefficient increases every time a non-zero coefficient is coded. Thus, the context control unit 104 may determine a context for SignificantFlag based on the coding order. In this case, it is desirable that the initial value of the symbol occurrence probability which corresponds to each context be set according to the above expectation. This allows further improvement in the coding efficiency.

Although the context control unit 104 first selects a context set and then determines a context in the above description, it does not always need to select a context set in the above manner. In other words, it may be possible that the context control unit 104 does not select a context set and determines, as a context for arithmetic coding of SignificantFlag, one of a plurality of contexts, based on the end position.

It is to be noted that the above-described information on the threshold, the binarization method, or the method of selecting a context may be recorded at the beginning of a bit stream (on a stream header). By so doing, the binarization method or the combination of contexts can be changed according to characteristics of an image, with the result that further improvement of the coding efficiency can be expected.

In addition, a unit of recoding into the header may be a unit which corresponds to a slice or a picture instead of a stream. In this case, the arithmetic coding method can be controlled in more detail as compared to the case of recording in units of streams, with the result that further improvement of the coding efficiency can be expected.

It is to be noted that although the arithmetic coding of SignificantFlag has been described, the arithmetic coding may be performed on Level and Sign as in the case of SignificantFlag. In other words, it is sufficient that the context control unit 104 determines a context for arithmetic coding of at least one of SignificantFlag, Level, and Sign, based on the position of the last non-zero coefficient.

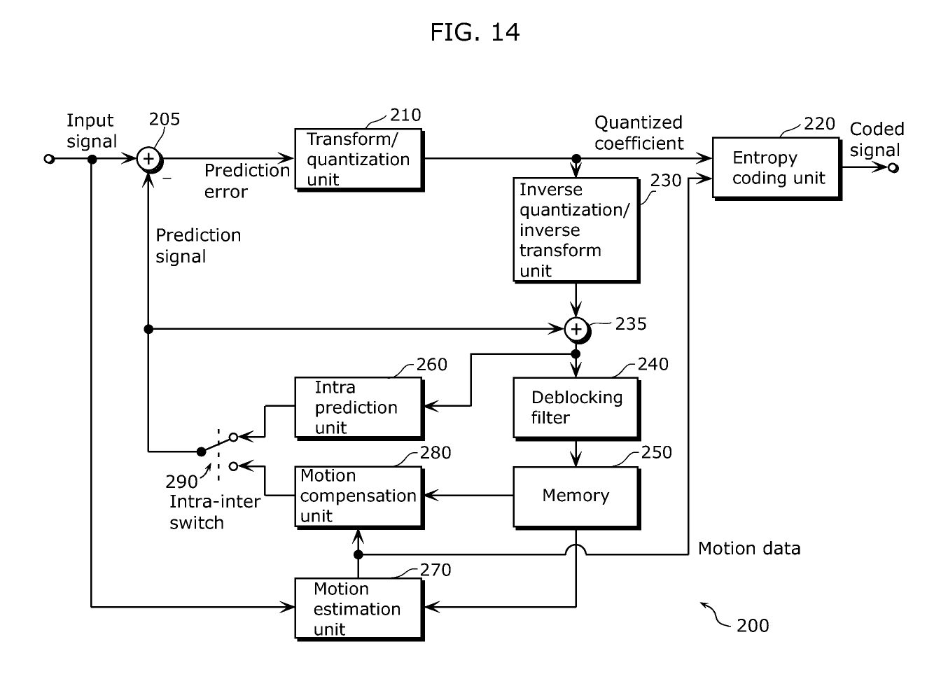

The arithmetic coding unit 100 according to Embodiment 1 of the present invention is included in an image coding apparatus which compresses and codes image data. FIG. 14 is a block diagram showing an example of a structure of an image coding apparatus 200 according to Embodiment 1 of the present invention.

The image coding apparatus 200 compresses and codes image data. For example, the image coding apparatus 200 receives, for each block, the image data as an input signal. The image coding apparatus 200 performs transform, quantization, and entropy coding on the received input signal, to generate a coded signal.

As shown in FIG. 14, the image coding apparatus 200 includes a subtractor 205, a transform/quantization unit 210, an entropy coding unit 220, an inverse quantization/inverse transform unit 230, an adder 235, a deblocking filter 240, a memory 250, an intra prediction unit 260, a motion estimation unit 270, a motion compensation unit 280, and an intra-inter switch 290.

The subtractor 205 calculates a difference between an input signal and a prediction signal, that is, a prediction error.

The transform/quantization unit 210 transforms a prediction error in the spatial domain to generate a transform coefficient in the frequency domain. For example, the transform/quantization unit 210 generates a transform coefficient by performing a discrete cosine transform (DCT) on the prediction error. Furthermore, the transform/quantization unit 210 generates a quantized coefficient by quantizing the transform coefficient.

The entropy coding unit 220 generates a coded signal by performing entropy coding on the quantized coefficient. Furthermore, the entropy coding unit 220 codes motion data (for example, a motion vector) estimated by the motion estimation unit 270 and includes the coded motion data in the coded signal, thereafter outputting the resultant coded signal.

The inverse quantization/inverse transform unit 230 reconstructs the transform coefficient by inverse-quantizing the quantized coefficient. Furthermore, the inverse quantization/inverse transform unit 230 reconstructs the prediction error by inverse-transforming the reconstructed transform coefficient. Because of information loss due to the quantization, the reconstructed prediction error is not identical to the prediction error generated by the subtractor 205. In other words, the reconstructed prediction error includes a quantization error.

The adder 235 generates a local decoded image by adding the reconstructed prediction error and the prediction signal.

The deblocking filter 240 performs a deblocking filter process on the generated local decoded image.

The memory 250 is a memory for storing a reference image to be used for motion compensation. Specifically, the memory 250 stores the local decoded image on which the deblocking filter process has been performed.

The intra prediction unit 260 generates a prediction signal (an intra prediction signal) by performing intra prediction. Specifically, the intra prediction unit 260 performs the intra prediction with reference to images around a coding target block (an input signal) in the local decoded image generated by the adder 235, to thereby generate the intra prediction signal.

The motion estimation unit 270 estimates motion data (for example, a motion vector) between the input signal and the reference image stored in the memory 250.

The motion compensation unit 280 generates a prediction signal (an inter prediction signal) by performing motion compensation based on the estimated motion data.

The intra-inter switch 290 selects one of the intra prediction signal and the inter prediction signal and outputs the selected signal as the prediction signal to the subtractor 205 and the adder 235.

With the above structure, the image coding apparatus 200 according to Embodiment 1 of the present invention compresses and codes the image data.

It is to be noted that, in FIG. 14, the arithmetic coding unit 100 according to Embodiment 1 of the present invention is included in the entropy coding unit 220. This means that the arithmetic coding unit 100 performs binarization and arithmetic coding on the quantized coefficient as the input signal SI. The signal type information SE is information which indicates the coefficient position of the quantized coefficient, the motion data shown in FIG. 14, the direction of intra prediction used by the intra prediction unit 260, or the like.

As above, according to the image coding apparatus and the image coding method according to Embodiment 1 of the present invention, it is possible at the time of coding the end position information and the coefficient information to appropriately perform the binarization and appropriately determine a context for arithmetic coding of a binarization result.

This allows a reduction in the length of a binary signal to be coded and a reduction in the number of contexts while allowing the probability information which reflects the total statistical information, to be used as the coding probability information, with the result that the coding efficiency can be increased. In other words, it is possible to increase the coding efficiency while reducing the size of memory for holding the probability information.

It is to be noted that there is no need to execute the entire processing included in the above arithmetic coding method. Specifically, although this embodiment illustrates processing which is characteristic to both of the arithmetic coding of the end position information and the arithmetic coding of the coefficient information, it may also be possible to include the processing which is characteristic to only one of the above, for example.

For example, it is sufficient that the arithmetic coding unit determines, based on the end position, a context for arithmetic coding of a plurality of coefficients and performs the arithmetic coding on the binary signal using a context which corresponds to the determined context. The following describes such an arithmetic coding unit.

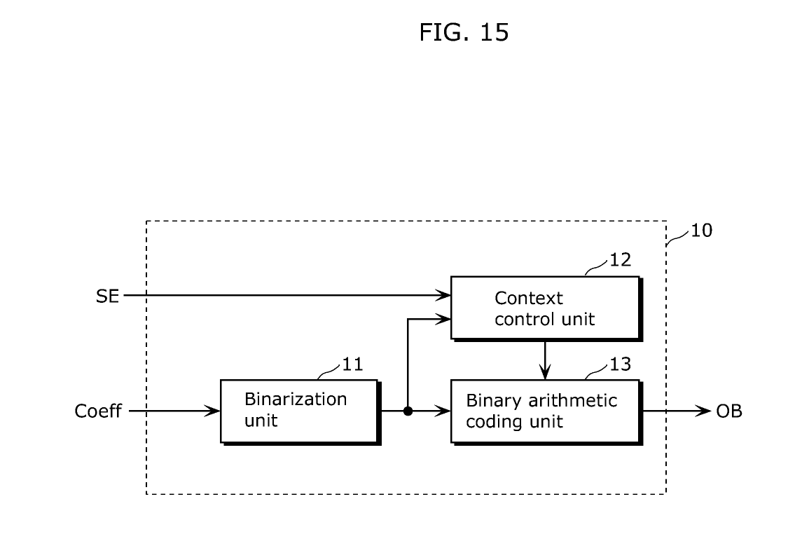

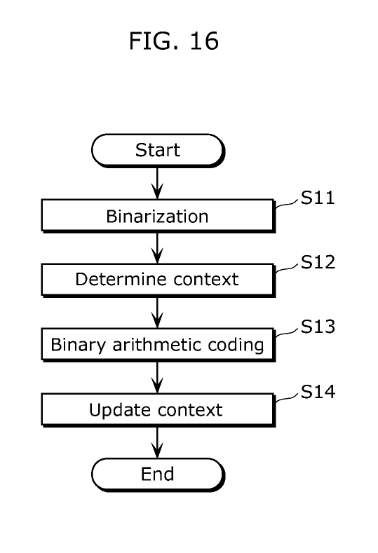

FIG. 15 is a block diagram showing an example of a structure of an image decoding apparatus 10 according to an implementation of the present invention. The image coding apparatus 10 compresses and codes image data. As shown in FIG. 15, the arithmetic coding unit 10 includes a binarization unit 11, a context control unit 12, and a binary arithmetic coding unit 13. Each constituent of the arithmetic coding unit 10 is described in detail with reference to FIG. 16.

FIG. 16 is a flowchart showing a processing operation of the arithmetic coding unit 10 according to an implementation of the present invention.

First, the binarization unit 11 generates a binary signal by binariziaing a plurality of coefficients included in a unit of processing in a frequency domain (S11). Specifically, the binarization unit 11 generates a binary signal corresponding to each of SignificantFlag, Level, and Sign, for example.

The context control unit 12 determines a context for arithmetic coding of a plurality of coefficients, based on the position of the last non-zero coefficient in a scan order among non-zero coefficients included in the unit of processing (S12). The context indicates information for specifying probability information which indicates an occurrence probability of a value of a symbol included in the binary signal. The context control unit 12 holds the probability information in association with each of a plurality of contexts.

The binary arithmetic coding unit 13 performs the arithmetic coding on the binary signal by using the probability information which corresponds to the determined context (S13). Specifically, the binary arithmetic coding unit 13 obtains, from the context control unit 12, the probability information which corresponds to the determined context, among a plurality of pieces of the probability information held in a memory. The binary arithmetic coding unit 13 then performs, using the obtained probability information, the arithmetic coding on the binary signal.

The context control unit 12 updates, based on the binary signal, the probability information which corresponds to the determined context (S14). Specifically, based on the value of a symbol included in the binary signal, the context control unit 12 updates the probability information which is held in the memory and corresponds to the determined context.

As above, even the arithmetic coding unit 10 shown in FIG. 15 and FIG. 16 is capable of appropriately determining, based on the position of the last non-zero coefficient in the scan order, a context for arithmetic coding of a plurality of coefficients, which allows improvement in the coding efficiency.

### Embodiment 2

Next, an outline of an arithmetic decoding method according to Embodiment 2 of the present invention is described. In the arithmetic decoding method according to this embodiment, when arithmetic decoding is performed on a plurality of coefficients resulting from arithmetic coding, a context for arithmetic decoding of the plurality of coefficients is determined based on end position information indicating the position of the last non-zero coefficient in the scan order. Using a symbol occurrence probability which corresponds to the determined context, the arithmetic decoding is performed on the plurality of coefficients. With this, the symbol occurrence probability based on statistical information can be used, which allows improvement in the coding efficiency. Furthermore, it is possible to appropriately set the number of contexts and thereby possible to appropriately set the number of symbol occurrence probabilities to be held, so that a memory size at the time of implementation can be reduced.

Furthermore, it is possible to appropriately use the symbol occurrence probability also in arithmetic decoding of the end position information, which allows improvement in the coding efficiency.

The above is a description about the outline of the arithmetic decoding method according to this embodiment.

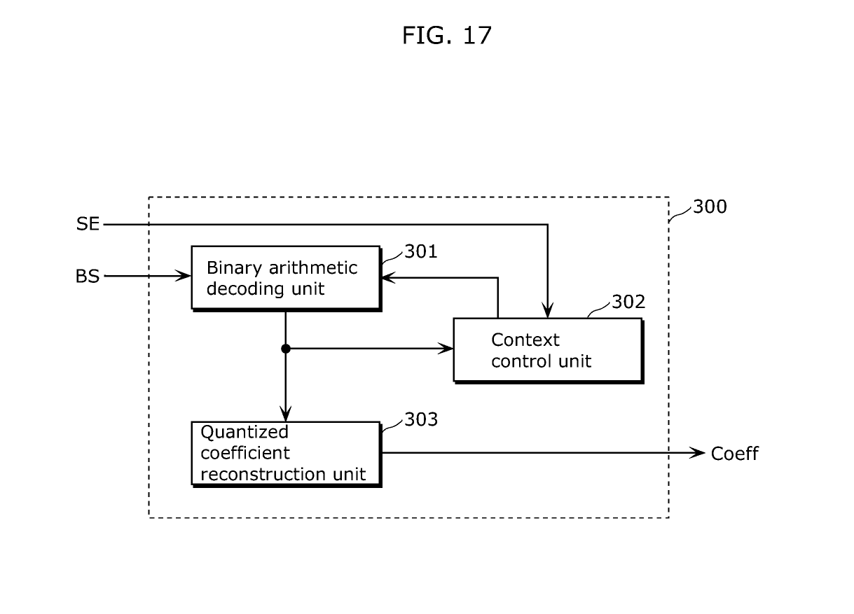

Next, a structure of an arithmetic decoding unit according to this embodiment is described. FIG. 17 is a block diagram showing an example of a structure of an arithmetic decoding unit 300 according to Embodiment 2 of the present invention. As will be described below, the arithmetic decoding unit 300 according to Embodiment 2 of the present invention corresponds to a part of an image decoding apparatus which decodes compressed and coded image data.

The arithmetic decoding unit 300 receives, as input, an input signal BS corresponding to a quantized coefficient to be decoded, and signal type information SE on the input signal BS. The arithmetic decoding unit 300 reconstructs a coefficient signal Coeff by performing decoding processing on the input signal BS.

As shown in FIG. 17, the arithmetic decoding unit 300 includes a binary arithmetic decoding unit 301, a context control unit 302, and a quantized coefficient reconstruction unit 303.

The arithmetic decoding unit 301 generates a binary signal by performing, using the symbol occurrence probability obtained from the context control unit 302, arithmetic decoding on the input signal BS which corresponds to the end position information and the coefficient information.

The context control unit 302 includes a memory (not shown) or the like which holds a plurality of symbol occurrence probabilities. The context control unit 302 refers, for example, to a symbol occurrence probability table to specify, among the plurality of symbol occurrence probabilities stored in the memory, a symbol occurrence probability which corresponds to the context. The symbol occurrence probability table is a table in which contexts and probability information are associated. The symbol occurrence probability table is, for example, the table shown in FIG. 5. The details of the symbol occurrence probability table are similar to those in Embodiment 1 and therefore not described again.

In addition, the context control unit 302 further holds a context table. The context table is a table in which types of the decoding target signal and contexts are associated. The context table is, for example, the table shown in FIG. 6. The details of the context table are similar to those in Embodiment 1 and therefore not described again.

The quantized coefficient reconstruction unit 303 reconstructs a plurality of coefficients (a unit of processing in a frequency domain) using the binary signal generated by the binary arithmetic decoding unit 301.

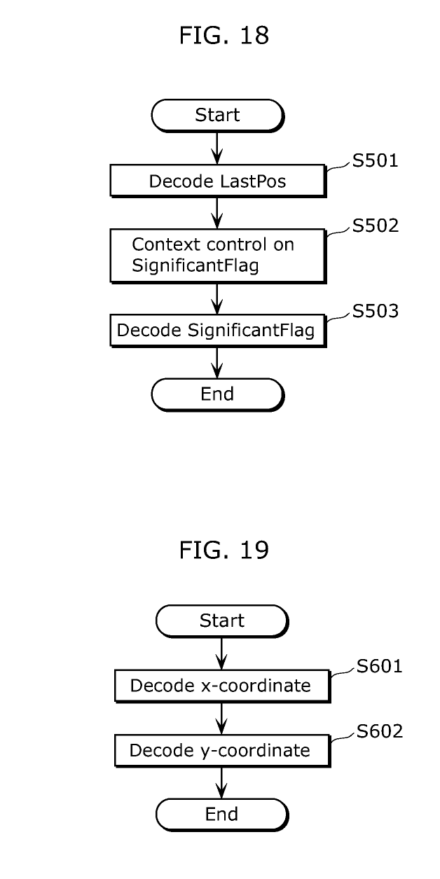

Next, an operation of the arithmetic decoding unit 300 configured as above is described with reference to FIG. 18. FIG. 18 is a flowchart showing an example of processing operation of the arithmetic decoding unit 300 according to Embodiment 2 of the present invention.

The binary arithmetic decoding unit 301 first obtains the input signal (the bit stream) which corresponds to the end coefficient information (LastPos). The context control unit 302 obtains the signal type information SE which corresponds to the obtained input signal. The context control unit 302 then determines, based on the signal type, a context for arithmetic decoding of the end position information. Furthermore, the context control unit 302 outputs, to the binary arithmetic decoding unit 301, the symbol occurrence probability which corresponds to the determined context.

The binary arithmetic decoding unit 301 performs arithmetic decoding on the obtained input signal based on the symbol occurrence probability to decode the end position information by (Step S501). The decoded end coefficient information is output to the quantized coefficient reconstruction unit 303. Specifically, the binary arithmetic decoding unit 301 performs the arithmetic decoding on, one by one, the symbols included in the binary signal resulting from arithmetic coding. Thus, the decoding processing is repeated until decoding of all the symbols indicating the end coefficient information is completed. A context control method in this case is the same as the method used at the time of coding. Specifically, the context control method is the same as the method described in Embodiment 1.

Next, the binary arithmetic decoding unit 301 obtains the input signal (the bit stream) which corresponds to SignificantFlag. The context control unit 302 obtains the signal type information SE which corresponds to the obtained input signal. The context control unit 302 then determines, based on the signal type, a context for arithmetic decoding of SignificantFlag. Furthermore, the context control unit 302 outputs, to the binary arithmetic decoding unit 301, the symbol occurrence probability which corresponds to the determined context.

In this case, the context control unit 302 determines a context based on the already-decoded end position information (Step S502). Specifically, the context control unit 302 determines, based on the position of the last non-zero coefficient in the scan order, a context for arithmetic decoding of the input signal corresponding to the plurality of coefficients included in the unit of processing. A context control method is the same as the method used at the time of coding. Specifically, the context control method is the same as the method described in Embodiment 1.

The binary arithmetic decoding unit 301 performs arithmetic decoding on the obtained input signal based on the symbol occurrence probability to decode SignificantFlag (Step S503). The decoded SignificantFlag is output to the quantized coefficient reconstruction unit 303. Specifically, the binary arithmetic decoding unit 301 decodes, one by one, SignificantFlags included in the binary signal resulting from arithmetic coding. Thus, the decoding process is repeated until decoding of all the SignificantFlags is completed.

Lastly, the quantized coefficient reconstruction unit 303 reconstructs the coefficient signal Coeff based on the obtained end position information and the obtained SignificantFlag. More specifically, the quantized coefficient reconstruction unit 303 combines those pieces of information with Level and Sign to reconstruct the plurality of quantized coefficients. A method of decoding these Level and Sign may be a method specified in the H. 264 standard, for example.

The above is a description about the structure of the arithmetic decoding unit 300 according to this embodiment.

Next, an arithmetic decoding method for the input signal corresponding to the end position information (LastPos) is described. First, the arithmetic decoding method for the case where, at the time of coding, the end position information has been binarized by the first binarization method (in (e) of FIG. 8 in Embodiment 1) is described.

FIG. 19 is a flowchart showing an example of the arithmetic decoding method for the end position information according to Embodiment 2 of the present invention.

First, the context control unit 302 determines a context by a method which is the same or alike as the method described in Embodiment 1. The context control unit 302 then outputs, to the binary arithmetic decoding unit 301, the symbol occurrence probability which corresponds to the determined context. The binary arithmetic decoding unit 301 performs, using the symbol occurrence probability obtained from the context control unit 302, arithmetic decoding on the input signal corresponding to the x-coordinate (Step S601).

Next, the context control unit 302 determines a context by a method which is the same or alike as the method described in Embodiment 1. The context control unit 302 then outputs, to the binary arithmetic decoding unit 301, the symbol occurrence probability which corresponds to the determined context. The binary arithmetic decoding unit 301 performs, using the symbol occurrence probability obtained from the context control unit 302, arithmetic decoding on the input signal corresponding to the y-coordinate (Step S602).

Furthermore, Steps S601 and S602 in FIG. 19 are repeated for each symbol in the case where, based on a symbol included in a binary signal corresponding to one of the x-coordinate and the y-coordinate, a context for a binary signal corresponding to the other has been determined at the time of coding. The details of the method of determining a context are the same as those of the method described in Embodiment 1.

Next, the arithmetic decoding method for the case where, at the time of coding, the end position information has been binarized by the second binarization method (in (f) of FIG. 8 in Embodiment 1) is described.

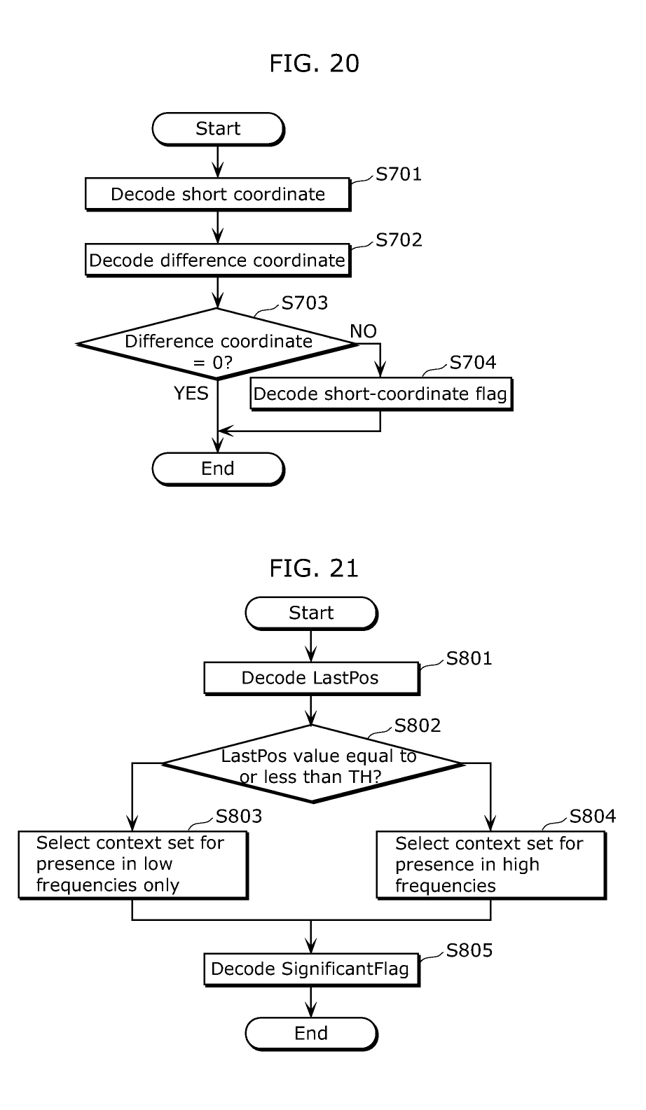

FIG. 20 is a flowchart showing another example of the arithmetic decoding method for the end position information according to Embodiment 2 of the present invention.

First, the context control unit 302 determines a context for arithmetic decoding of the input signal corresponding to the short coordinate, by a method which is the same or alike as the method described in Embodiment 1. The context control unit 302 then outputs, to the binary arithmetic decoding unit 301, the symbol occurrence probability which corresponds to the determined context. The binary arithmetic decoding unit 301 performs, using the symbol occurrence probability obtained from the context control unit 302, arithmetic decoding on the input signal corresponding to the short coordinate (Step S701).

Next, at this time, the context control unit 302 determines a context for arithmetic decoding of the input signal corresponding to the difference coordinate, by a method which is the same or alike as the method described in Embodiment 1. The context control unit 302 then outputs, to the binary arithmetic decoding unit 301, the symbol occurrence probability which corresponds to the determined context. The binary arithmetic decoding unit 301 performs, using the symbol occurrence probability obtained from the context control unit 302, arithmetic decoding on the input signal corresponding to the difference coordinate (Step S702).

Here, when the difference coordinate value resulting from arithmetic decoding of the input signal corresponding to the difference coordinate is “0” (YES in Step S703), the decoding process is brought to an end. This is because the x-coordinate value and the y-coordinate value are the same, which eliminates the need to distinguish the coordinate value resulting from the decoding in Step S701, between the x-coordinate value and the y-coordinate value.

On the other hand, when the difference coordinate value is not “0” (NO in Step S703), the binary arithmetic decoding unit 301 performs the arithmetic decoding on the input signal corresponding to the short-coordinate flag (Step S704). At this time, the context control unit 302 has determined a context in the same manner as in Embodiment 1 and output, to the binary arithmetic decoding unit 301, the symbol occurrence probability which corresponds to the determined context.

Next, the arithmetic decoding method for the input signal corresponding to SignificantFlag which is an example of the coefficient information is described.

FIG. 21 is a flowchart showing an example of the arithmetic decoding method according to Embodiment 2 of the present invention.

First, the binary arithmetic decoding unit 301 decodes the end position information (LastPos) by the above-described method (Step S801). Next, when the value obtained from LastPos is equal to or less than a threshold TH (YES in Step S802), the context control unit 302 selects a context set specific to the case where there are non-zero coefficients only in a low-frequency region (Step S803).

On the other hand, when the value obtained from LastPos is greater than the threshold TH (NO in Step S802), the context control unit 302 selects a context set specific to the case where there are non-zero coefficients also in a high-frequency region (Step S804).

Next, the context control unit 302 determines, from the selected context set, a context for arithmetic decoding of the input signal corresponding to SignificantFlag, by a predetermined means. Using the symbol occurrence probability which corresponds to the determined context, the binary arithmetic decoding unit 301 then performs the arithmetic decoding on the input signal corresponding to SignificantFlag (Step S805).

Here, in the case where LastPos is represented in a two-dimensional orthogonal coordinate system, the value obtained from LastPos is a value obtained from at least one of the two coordinate values that indicate LastPos. In other words, the context control unit 302 determines a context based on at least one of the two coordinate values that indicate the position of the last non-zero coefficient.

Specifically, the value obtained from LastPos is, for example, the sum of two coordinate values that indicate LastPos. In other words, the context control unit 302 determines a context based on the sum of two coordinate values. In this case, it is sufficient that the context control unit 104 compares (the x-coordinate value+the y-coordinate value) with the threshold TH in Step S402. By so doing, the context control unit 302 changes the context sets in such a way that, for example, when the threshold TH is “5”, a diagonal line passing through (0, 5), (1, 4), (2, 3), (3, 2), (4, 1), and (5, 0) is a boundary.

Alternatively, the value obtained from LastPos may be, for example, a larger one of the two coordinate values that indicate LastPos. In other words, the context control unit 302 determines a context based only on the larger one of the two coordinate values. In this case, it is sufficient that the context control unit 104 compares MAX (the x-coordinate value, the y-coordinate value) with the threshold TH in Step S402. For example, when the threshold TH is “5”, the context control unit 302 changes the context sets in such a way that a straight line passing through (0, 5) and (5, 5) and a straight line passing through (5, 0) and (5, 5) are boundaries.

Although there is one threshold TH here, there may be a plurality of thresholds. With the plurality of thresholds TH, it is possible to switch among three or more context sets based on LastPos. In this case, more detailed prediction of the symbol occurrence probabilities is possible, with the result that improvement in the coding efficiency can be expected.

It is to be noted that the method of determining a context must be the same method as that used at the time of coding.

Furthermore, in Step S805, it is sufficient that the binary arithmetic decoding unit 301 performs the arithmetic decoding on the input signal obtained by performing, in the scan order, arithmetic coding on the sequence of symbols located before the position denoted by Last in (c) of FIG. 8. In this case, the context control unit 302 determines a context based on the coefficient position as described in Embodiment 1. Furthermore, for example, the context control unit 302 may determine a context based on the number of adjacent zero coefficients or adjacent non-zero coefficients.

Furthermore, for example, the context control unit 302 may determine a context based on both of the coefficient position and the number of adjacent zero coefficients or adjacent non-zero coefficients. More specifically, it may be possible, for example, that the context control unit 302 determines a context based on the coefficient position in the case of a low-frequency region while determining a context based on the number of adjacent zero coefficients or adjacent non-zero coefficients in the case of a high-frequency region.

Furthermore, in the case where SignificantFlag has been coded in the reverse scan order from the end position, it is sufficient that the arithmetic decoding unit 300 performs the decoding processing likewise in the reverse scan order. In this case, it is expected that the probability of occurrence of a non-zero coefficient increases every time a non-zero coefficient is coded. Thus, the context control unit 302 may determine a context for the input signal corresponding to SignificantFlag, based on the coding order. In this case, it is desirable that the initial value of the symbol occurrence probability which corresponds to each context be set according to the above expectation. This allows further improvement in the coding efficiency.

Although the context control unit 302 first selects a context set and then determines a context in the above description, it does not always need to select a context set in the above manner. In other words, it may be possible that the context control unit 302 does not select a context set and determines, as a context for arithmetic decoding of the input signal corresponding to SignificantFlag, one of a plurality of contexts, based on the end position.

It is to be noted that although the arithmetic decoding of the input signal corresponding to SignificantFlag has been described, the arithmetic decoding may be performed also on the input signals corresponding to Level and Sign as in the case of SignificantFlag. In other words, it is sufficient that the context control unit 302 determines a context for arithmetic decoding of the input signal corresponding to at least one of SignificantFlag, Level, and Sign, based on the position of the last non-zero coefficient.

It is to be noted that the context control unit 302 obtains the binary signal decoded by the binary arithmetic decoding unit 301 and performs, every time the binary arithmetic decoding is performed, processing of updating the symbol occurrence probability which corresponds to the context used in the arithmetic decoding. For the processing of updating the symbol occurrence probability, the method specified in the H.264 standard is used, for example.

By adopting the above method, it becomes possible to decode the signal coded with the improved coding efficiency.

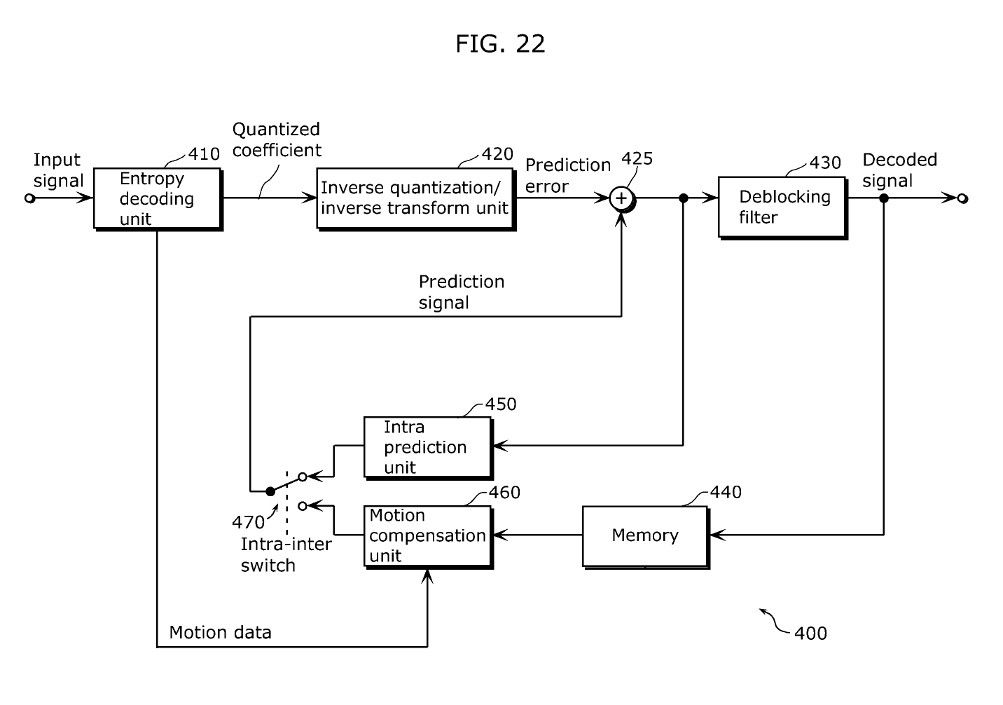

The arithmetic decoding unit 300 according to Embodiment 2 of the present invention is included in an image decoding apparatus which decodes compressed and coded image data. FIG. 22 is a block diagram showing an example of a structure of an image decoding apparatus 400 according to Embodiment 3 of the present invention.

The image decoding apparatus 400 decodes compressed and coded image data. For example, the image decoding apparatus 400 receives, for each block, the coded image data as the decoding target signal. The image decoding apparatus 400 performs entropy decoding, inverse quantization, and inverse transform on the received decoding target signal, to reconstruct the image data.

As shown in FIG. 22, the image decoding apparatus 400 includes an entropy decoding unit 410, an inverse quantization/inverse transform unit 420, an adder 425, a deblocking filter 430, a memory 440, an intra prediction unit 450, a motion compensation unit 460, and an intra-inter switch 470.

The entropy decoding unit 410 performs the entropy decoding on the input signal (the input stream) to reconstruct the quantized coefficient. Here, the input signal (the input stream) is the decoding target signal and corresponds to data of each block of the coded image data. Furthermore, the entropy decoding unit 410 obtains motion data from the input signal and outputs the obtained motion data to the motion compensation unit 460.

The inverse quantization/inverse transform unit 420 reconstructs the transform coefficient by inverse-quantizing the quantized coefficient reconstructed by the entropy decoding unit 410. Furthermore, the inverse quantization/inverse transform unit 420 reconstructs the prediction error by inverse-transforming the reconstructed transform coefficient.

The adder 425 generates a decoded image by adding the reconstructed prediction error and the prediction signal.

The deblocking filter 430 performs a deblocking filter process on the generated decoded image. The decoded image on which the deblocking filter process has been performed is output as a decoded signal.

The memory 440 is a memory for storing a reference image to be used for motion compensation. Specifically, the memory 440 stores the decoded image on which the deblocking filter process has been performed.

The intra prediction unit 450 generates a prediction signal (an intra prediction signal) by performing intra prediction. Specifically, the intra prediction unit 450 performs the intra prediction with reference to images around a decoding target block (an input signal) in the decoded image generated by the adder 425, to thereby generate the intra prediction signal.

The motion compensation unit 460 generates a prediction signal (an inter prediction signal) by performing motion compensation based on the motion data outputted from the entropy decoding unit 410

The intra-inter switch 470 selects one of the intra prediction signal and the inter prediction signal and outputs the selected signal as the prediction signal to the adder 425.

With the above structure, the image decoding apparatus 400 according to Embodiment 2 of the present invention decodes compressed and coded image data.

It is to be noted that, in FIG. 22, the arithmetic coding unit 300 according to Embodiment 2 of the present invention is included in the entropy decoding unit 410. This means that the arithmetic decoding unit 300 performs the arithmetic decoding and multivalue conversion on the coded image data, in form of the input stream IS, on which the prediction coding has been executed. The signal type information SE is information which indicates the position of the quantized coefficient, the motion data, the direction of intra prediction used by the intra prediction unit 450, or the like.

It is to be noted that, in the case where the above-described information on the threshold, the binarization method, and the method of selecting a context have been recorded at the beginning of a bit stream (on a stream header), it may be possible that the arithmetic decoding unit 300 reads such recorded information and changes the binarization method or the combination of contexts. This makes it possible to decode a stream coded with further improved coding efficiency.

In addition, even when a unit of recoding into the header is a unit which corresponds to a slice or a picture, the decoding can be performed likewise.

As above, according to the image decoding apparatus and the image decoding method according to Embodiment 2 of the present invention, a context can be appropriately determined at the time of arithmetic decoding of the input signals corresponding to the end position information and the coefficient information.

This makes it possible to correctly decode the input signal coded with improved coding efficiency. Specifically, as described in Embodiment 1, the probability information which reflects the total statistical information can be used as the probability information, with the result that the coding efficiency can be increased. In other words, it is possible to increase the coding efficiency while reducing the size of memory in which storing is executed for each context.

In the above-described manner, the image decoding apparatus and the image decoding method according to Embodiment 2 of the present invention allow correct decoding of a signal coded with improved coding efficiency.

It is to be noted that there is no need to execute the whole arithmetic decoding method described above. Specifically, although this embodiment illustrates arithmetic decoding which is characteristic to both of the end position information and the coefficient information, it may also be possible to perform the arithmetic decoding which is characteristic to only one of the above, for example.

For example, it is sufficient that the arithmetic decoding unit determines, based on the end position, a context for arithmetic decoding of an input signal corresponding to a plurality of coefficients and performs the arithmetic decoding on the input signal using a context which corresponds to the determined context. The following describes such an arithmetic decoding unit.

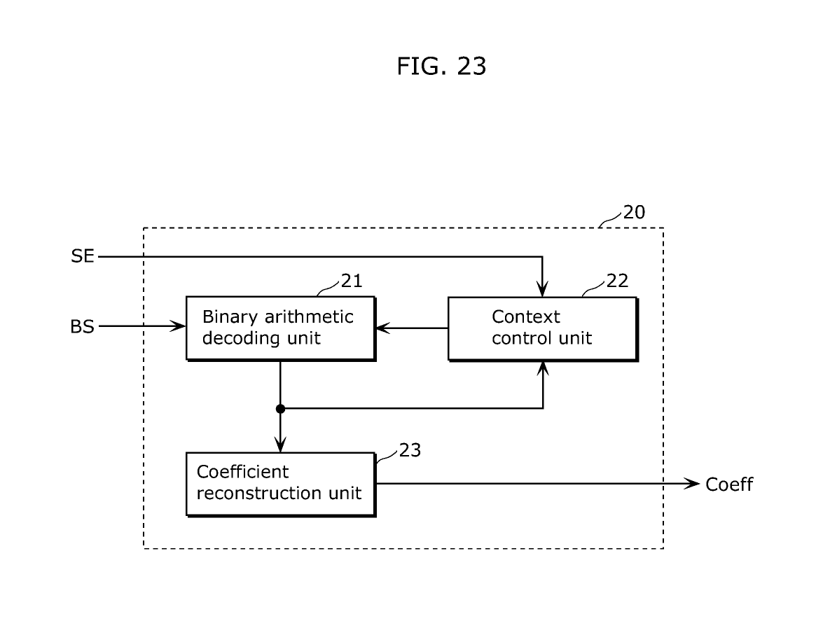

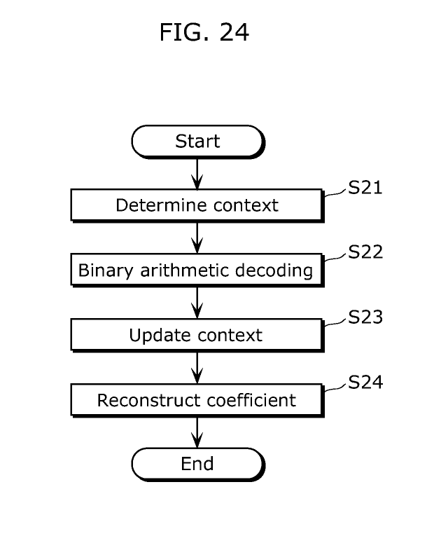

FIG. 23 is a block diagram showing an example of a structure of an image decoding apparatus 20 according to an implementation of the present invention. The image decoding apparatus 20 decodes compressed and coded image data. As shown in FIG. 23, the arithmetic decoding unit 20 includes a binary arithmetic decoding unit 21, a context control unit 22, and a coefficient reconstruction unit 23. Each constituent of the arithmetic decoding unit 20 is described in detail with reference to FIG. 24.

FIG. 24 is a flowchart showing a processing operation of the arithmetic decoding unit 20 according to an implementation of the present invention.

First, the context control unit 22 determines a context for arithmetic decoding of an input signal corresponding to a plurality of coefficients included in a unit of processing in a frequency domain, based on the position of the last non-zero coefficient in a scan order among non-zero coefficients included in the unit of processing (S21). The input signal corresponding to a plurality of coefficients indicates a signal resulting from arithmetic coding of a binary signal which corresponds to each of SignificantFlag, Level, and Sign, for example.

The binary arithmetic decoding unit 21 generates a binary signal by performing the arithmetic decoding on the input signal using the probability information which corresponds to the determined context (S22). Specifically, the binary arithmetic decoding unit 21 obtains, from the context control unit 22, the probability information which corresponds to the determined context, among a plurality of pieces of the probability information held in a memory. The binary arithmetic decoding unit 21 then performs the arithmetic decoding on the input signal using the obtained probability information.

The context control unit 22 updates, based on the binary signal, the probability information which corresponds to the determined context (S23). Specifically, based on the value of a symbol included in the binary signal, the context control unit 22 updates the probability information which is held in the memory and corresponds to the determined context.

The coefficient reconstruction unit 23 reconstructs, using the binary signal, the plurality of coefficients included in the unit of processing (S24). Specifically, the coefficient reconstruction unit 23 reconstructs Level by converting the binary signal corresponding to Level into multi-values. The coefficient reconstruction unit 23 then reconstructs the unit of processing based on the position of the last non-zero coefficient, SignificantFlag, Level, and Sign.

As above, even the arithmetic decoding unit 20 shown in FIG. 23 and FIG. 24 is capable of, based on the position of the last non-zero coefficient in the scan order, appropriately determining a context for arithmetic decoding of an input signal corresponding to a plurality of coefficients. Thus, the arithmetic decoding unit 20 is capable of appropriately decoding the input signal coded with high coding efficiency.

### Embodiment 3

The processing described in each of Embodiments can be simply implemented in an independent computer system, by recording, in a recording medium, a program for implementing the configuration of the moving picture coding method (the image coding method) or the moving picture decoding method (the image decoding method) described in the embodiment. The recording media may be any recording media as long as the program can be recorded, such as a magnetic disk, an optical disk, a magnetic optical disk, an IC card, and a semiconductor memory.

Hereinafter, the applications to the moving picture coding method (the image coding method) and the moving picture decoding method (the image decoding method) described in Embodiments and systems using them will be described. This system is characterized by including an image coding and decoding apparatus composed of the image coding apparatus using the image coding method and the image decoding apparatus using the image decoding method. The other structure of the system can be appropriately changed depending on situations.

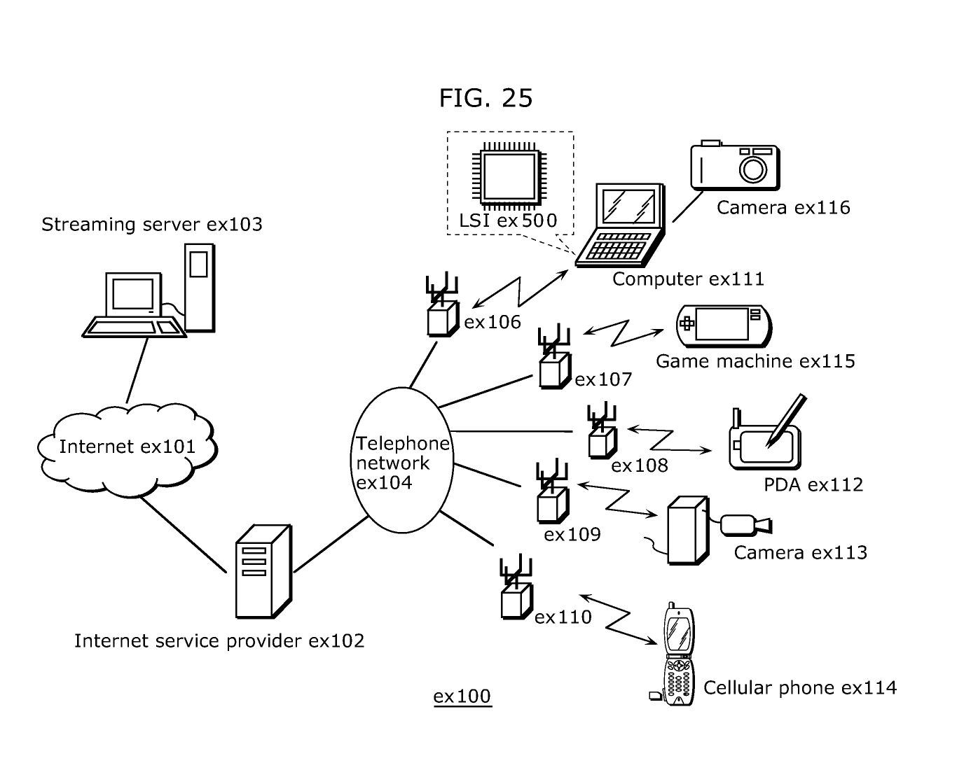

FIG. 25 illustrates an overall configuration of a content providing system ex100 for implementing content distribution services. The area for providing communication services is divided into cells of desired size, and base stations ex107, ex108, ex109, and ex110 which are fixed wireless stations are placed in each of the cells. The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 25, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital video camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in Embodiments (that is, the system functions as the image coding apparatus according to an implementation of the present invention), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the received data (that is, the system functions as the image decoding apparatus according to the implementation of the present invention).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be synthesized into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the image data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

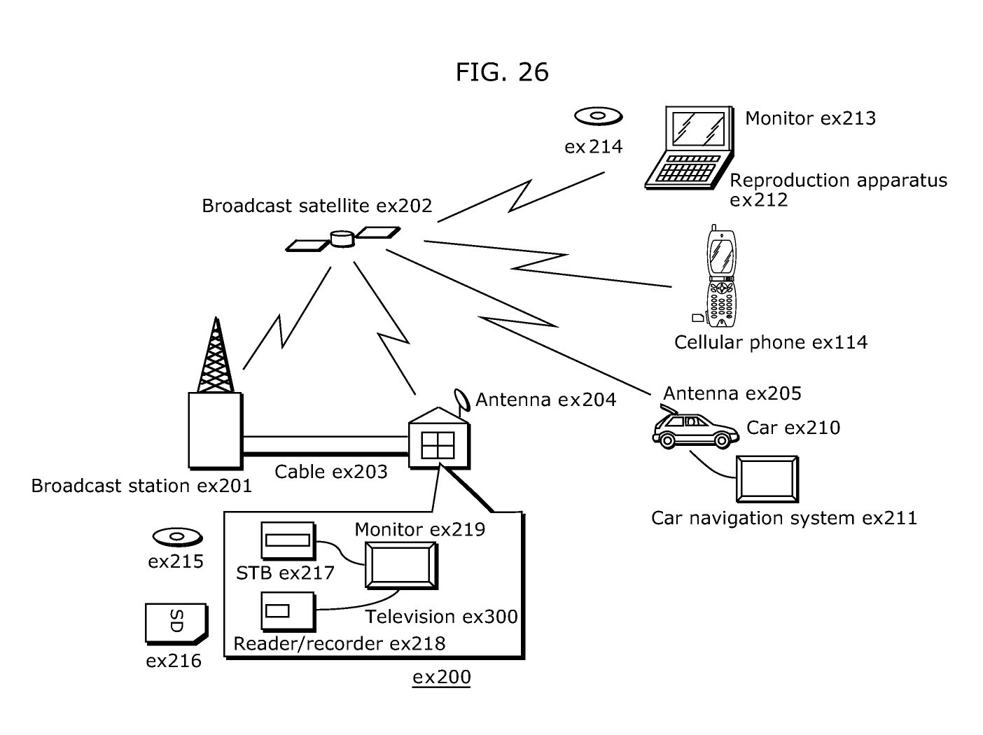

Aside from the example of the content providing system ex100, at least one of the moving picture coding apparatus (the image coding apparatus) and the moving picture decoding apparatus (the image decoding apparatus) described in each of Embodiments may be implemented in a digital broadcasting system ex200 illustrated in FIG. 26. More specifically, a broadcast station ex201 communicates or transmits, via radio waves to a broadcast satellite ex202, multiplexed data obtained by multiplexing audio data and others onto video data. The video data is data coded by the moving picture coding method described in each of Embodiments (that is, the video data is data coded by the image coding apparatus according to an implementation of the present invention). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (that is, the system functions as the image decoding apparatus according to an implementation of the present invention).

Furthermore, a reader/recorder ex218 (i) reads and decodes the multiplexed data recorded on a recording media ex215, such as a DVD and a BD, or (ii) codes video signals in the recording medium ex215, and in some cases, writes data obtained by multiplexing an audio signal on the coded data. The reader/recorder ex218 can include the moving picture decoding apparatus or the moving picture coding apparatus as shown in each of Embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

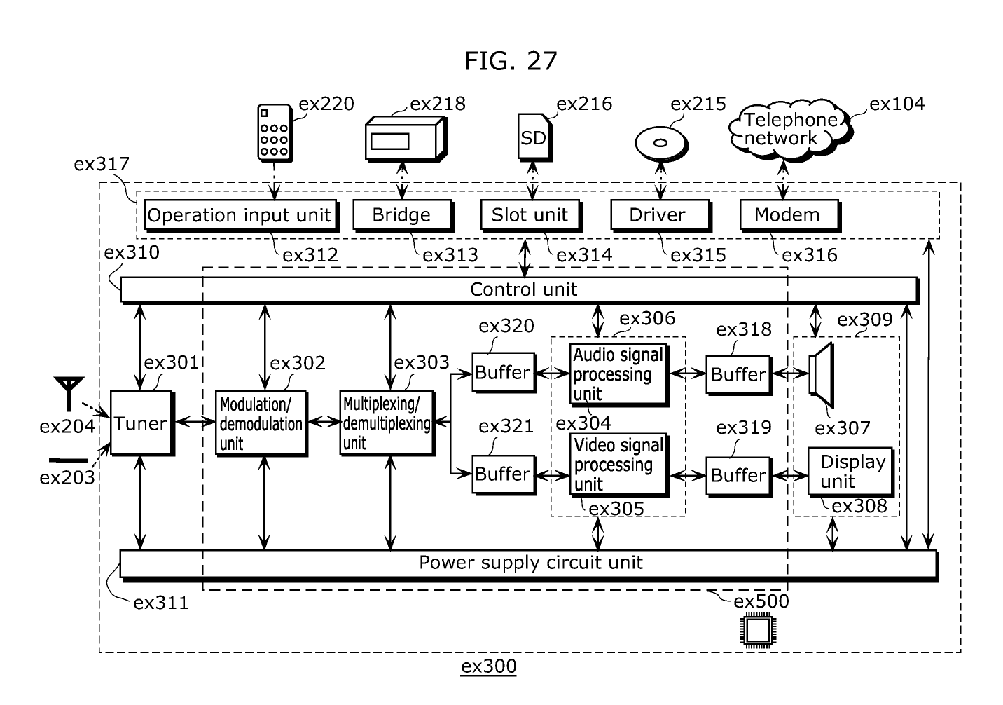

FIG. 27 illustrates the television (receiver) ex300 that uses the moving picture coding method and the moving picture decoding method described in each of Embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

Furthermore, the television ex300 further includes: a signal processing unit ex306 including an audio signal processing unit ex304 and a video signal processing unit ex305 (functioning as the image coding apparatus or the image decoding apparatus according to an implementation of the present invention) that decode audio data and video data and code audio data and video data, respectively; and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of Embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of Embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, although not illustrate, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

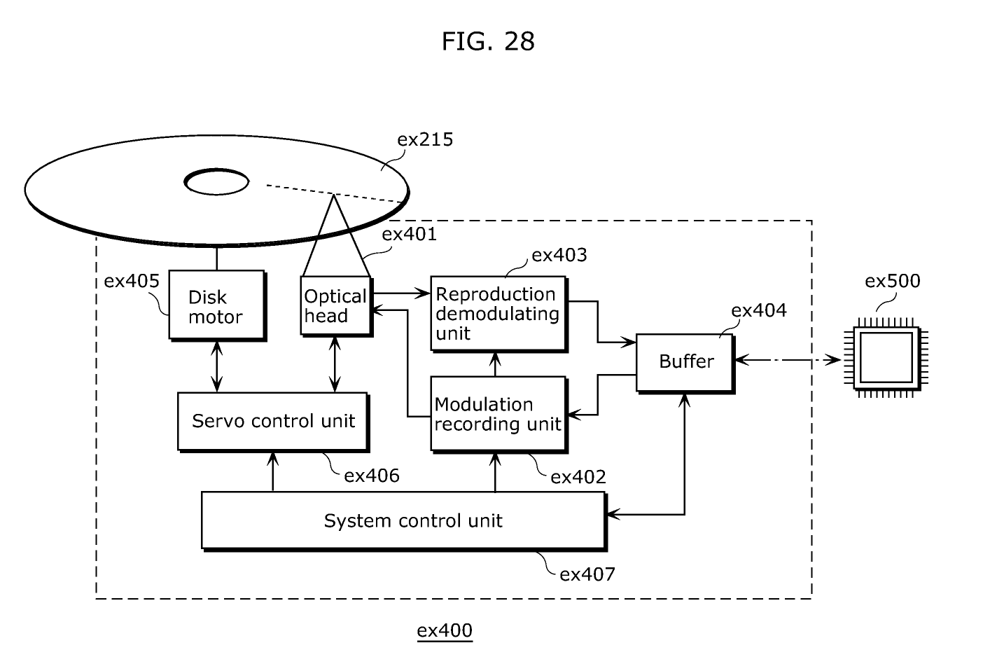

As an example, FIG. 28 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

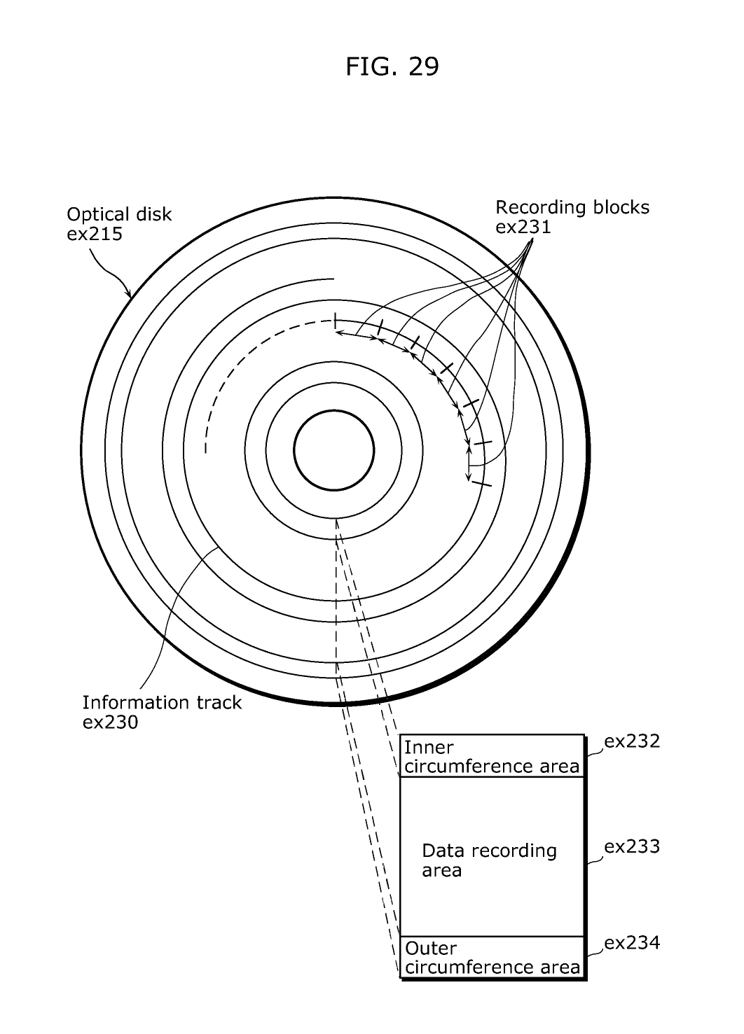

FIG. 29 schematically illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 27. The same will be true for the configuration of the computer ex111, the cellular phone ex114, and others.

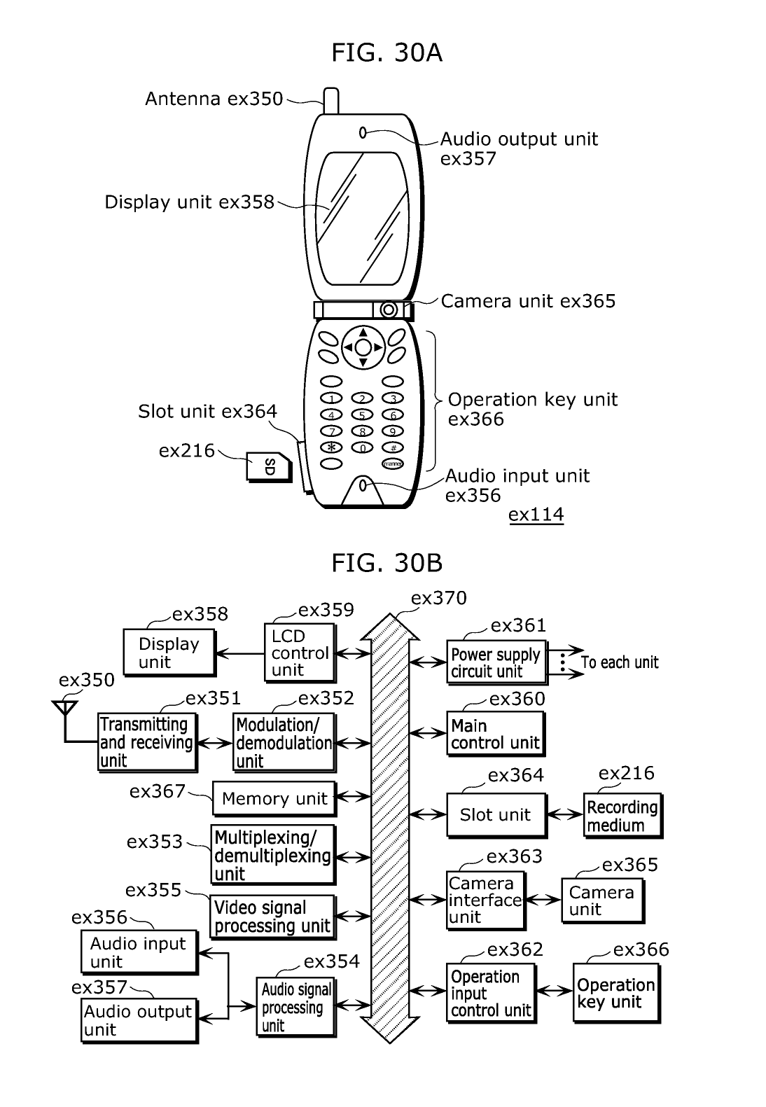

FIG. 30A illustrates the cellular phone ex114 that uses the moving picture coding method and the moving picture decoding method described in Embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 30B. In the cellular phone ex114, a main control unit ex360 designed to control overall each unit of the main body including the display unit ex358 as well as the operation key unit ex366 is connected mutually, via a bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in each of Embodiments (that is, the video signal processing unit ex355 functions as the image coding apparatus according to an implementation of the present invention), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation circuit unit (the modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of Embodiments (that is, the video signal processing unit ex355 functions as the image decoding apparatus according to an implementation of the present invention), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably has 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of Embodiments can be used in any of the devices and systems described. Thus, the advantages described in each of Embodiments can be obtained.

Furthermore, the present invention is not limited to Embodiments, and various modifications and revisions are possible without departing from the scope of the present invention.

### Embodiment 4

Video data can be generated by switching, as necessary, between (i) the moving picture coding method or the moving picture coding apparatus shown in each of Embodiments and (ii) a moving picture coding method or a moving picture coding apparatus in conformity with a different standard, such as MPEG-2, MPEG4-AVC, and VC-1.

Here, when a plurality of video data that conforms to the different standards is generated and is then decoded, the decoding methods need to be selected to conform to the different standards. However, since to which standard each of the plurality of the video data to be decoded conforms cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of Embodiments will be hereinafter described. The multiplexed data is a digital stream in the MPEG2-Transport Stream format.

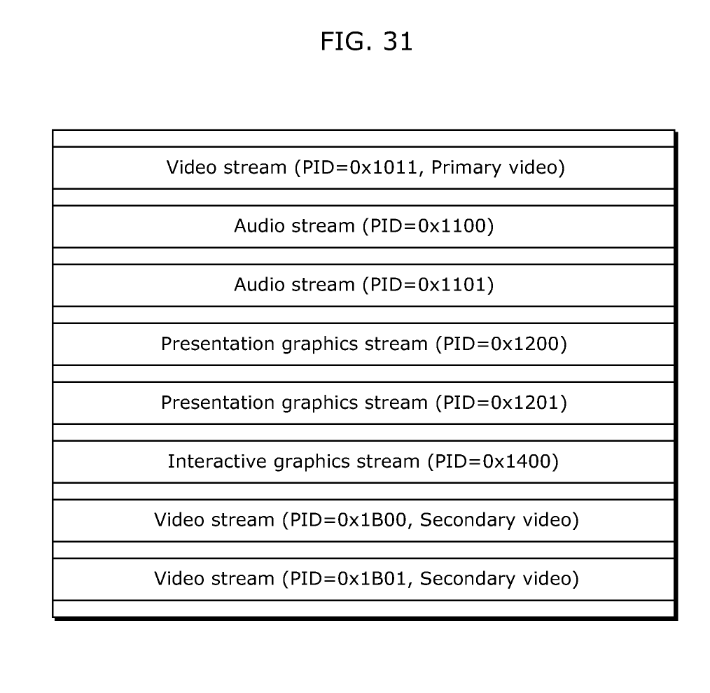

FIG. 31 illustrates a structure of the multiplexed data. As illustrated in FIG. 31, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of Embodiments, or in a moving picture coding method or by a moving picture coding apparatus in conformity with a conventional standard, such as MPEG-2, MPEG4-AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary video to be mixed with the primary audio.

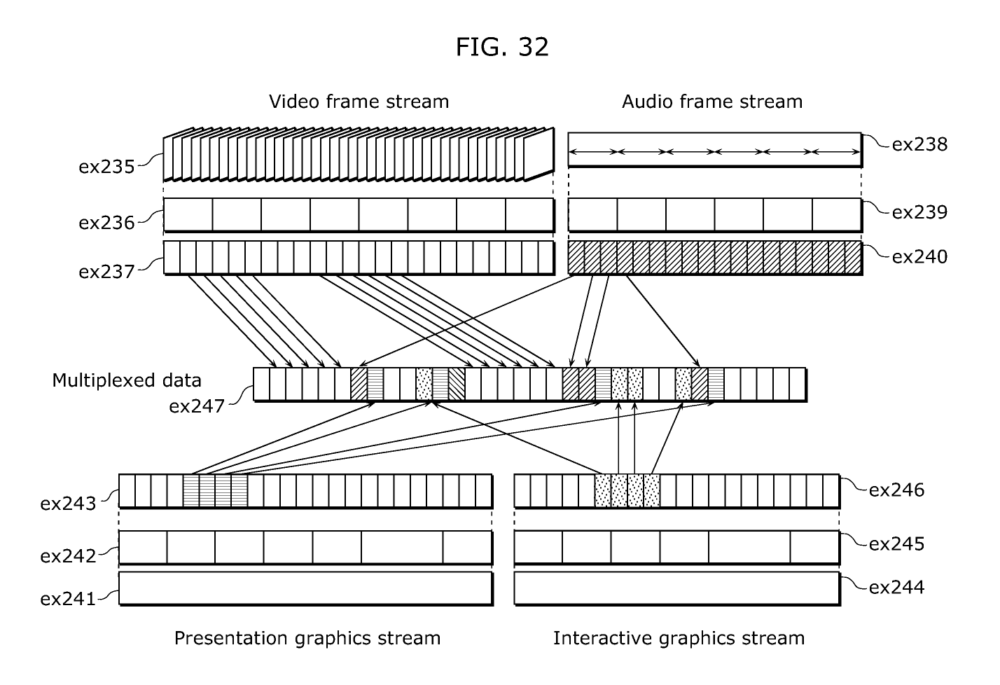

FIG. 32 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

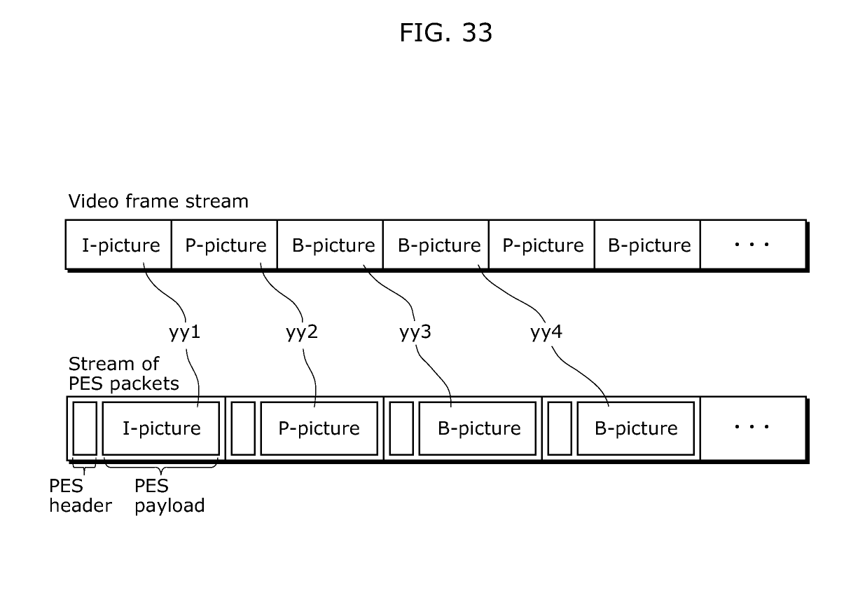

FIG. 33 illustrates how a video stream is stored in a stream of PES packets in more detail. The first bar in FIG. 33 shows a video frame stream in a video stream. The second bar shows the stream of PES packets. As indicated by arrows denoted as yy1, yy2, yy3, and yy4 in FIG. 33, the video stream is divided into pictures as I-pictures, B-pictures, and P-pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

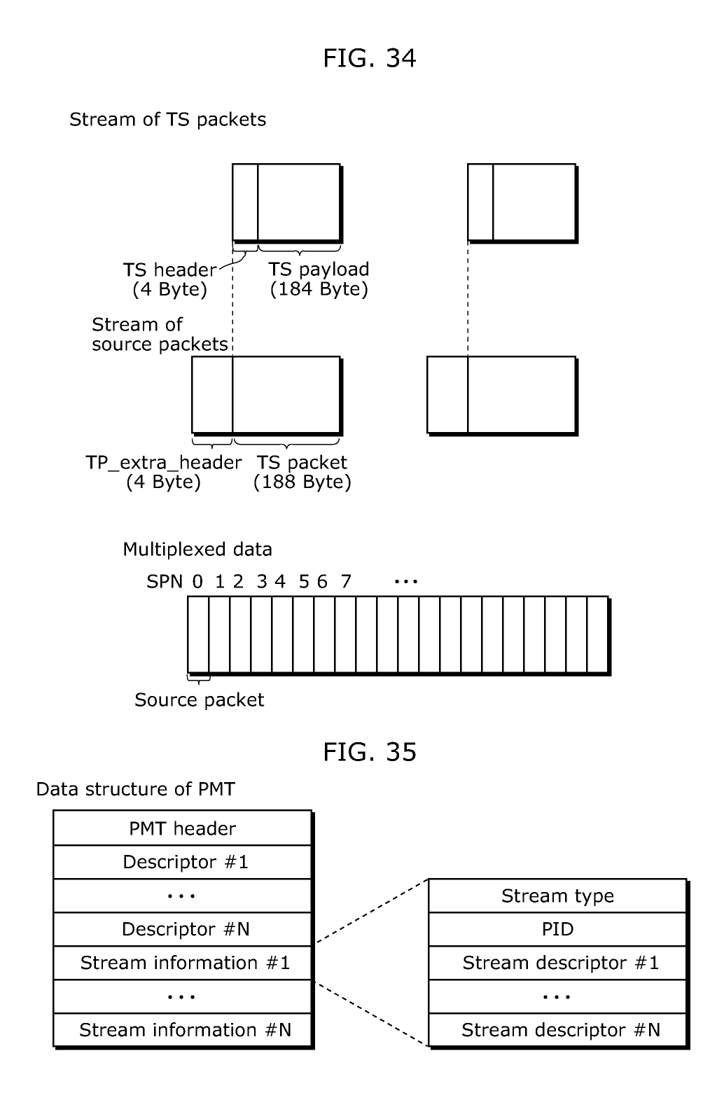

FIG. 34 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 34. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information on the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

FIG. 35 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

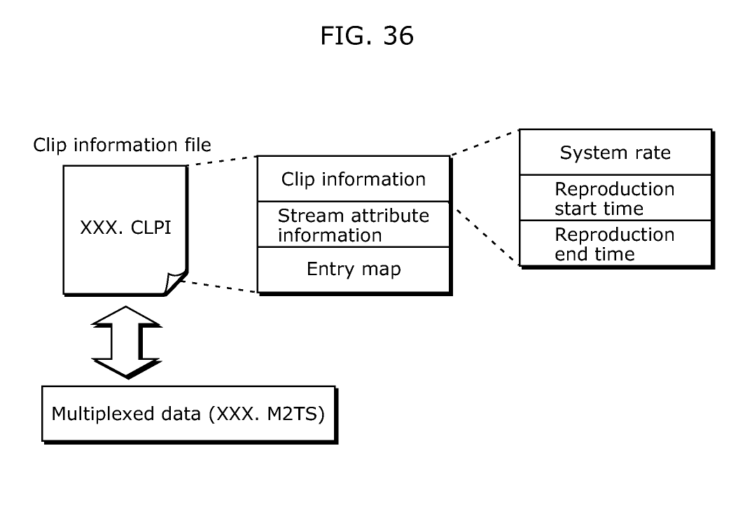

Each of the multiplexed data information files is management information on the multiplexed data as shown in FIG. 36. The multiplexed data information files are in one to one correspondence with the multiplexed data, and each of the files includes multiplexed data information, stream attribute information, and an entry map.

As illustrated in FIG. 36, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

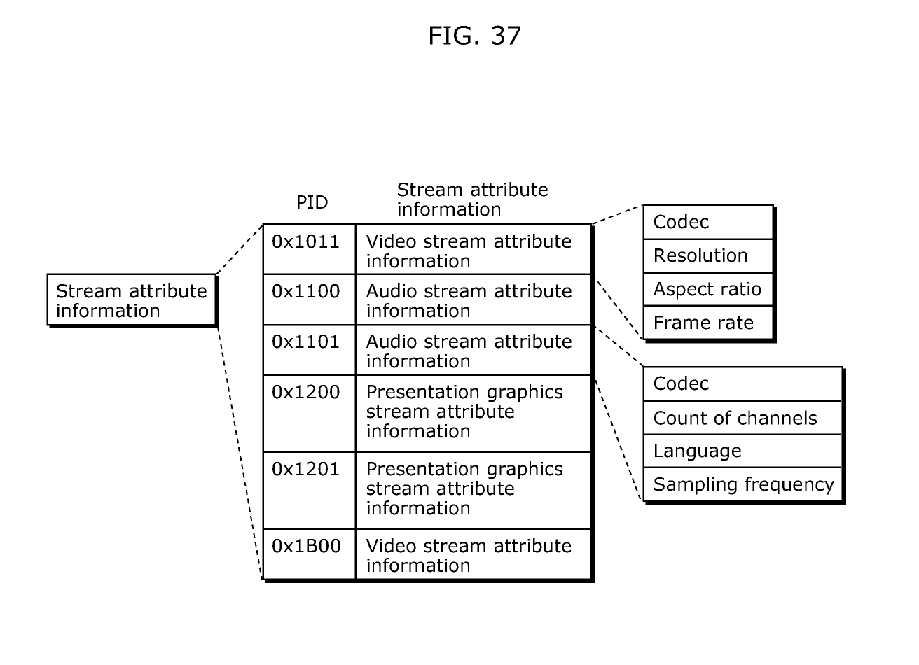

As shown in FIG. 37, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In this embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of Embodiments includes a step or a unit for allocating unique information indicating video data generated by the moving picture coding method or the moving picture coding apparatus in each of Embodiments, to the stream type included in the PMT or the video stream attribute information. With the configuration, the video data generated by the moving picture coding method or the moving picture coding apparatus described in each of Embodiments can be distinguished from video data that conforms to another standard.

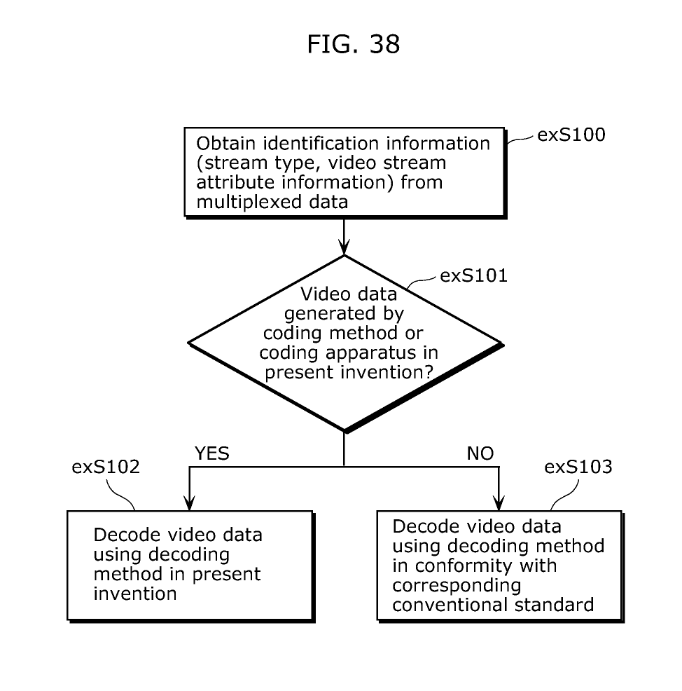

Furthermore, FIG. 38 illustrates steps of the moving picture decoding method according to this embodiment. In Step exS100, the stream type included in the PMT or the video stream attribute information is obtained from the multiplexed data. Next, in Step exS101, it is determined whether or not the stream type or the video stream attribute information indicates that the multiplexed data is generated by the moving picture coding method or the moving picture coding apparatus in each of Embodiments. When it is determined that the stream type or the video stream attribute information indicates that the multiplexed data is generated by the moving picture coding method or the moving picture coding apparatus in each of Embodiments, in Step exS102, decoding is performed by the moving picture decoding method in each of Embodiments. Furthermore, when the stream type or the video stream attribute information indicates conformance to the conventional standards, such as MPEG-2, MPEG4-AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of Embodiments can perform decoding. Even when multiplexed data that conforms to a different standard, an appropriate decoding method or apparatus can be selected. Thus, it becomes possible to decode information without any error. Furthermore, the moving picture coding method or apparatus, or the moving picture decoding method or apparatus in this embodiment can be used in the devices and systems described above.

### Embodiment 5

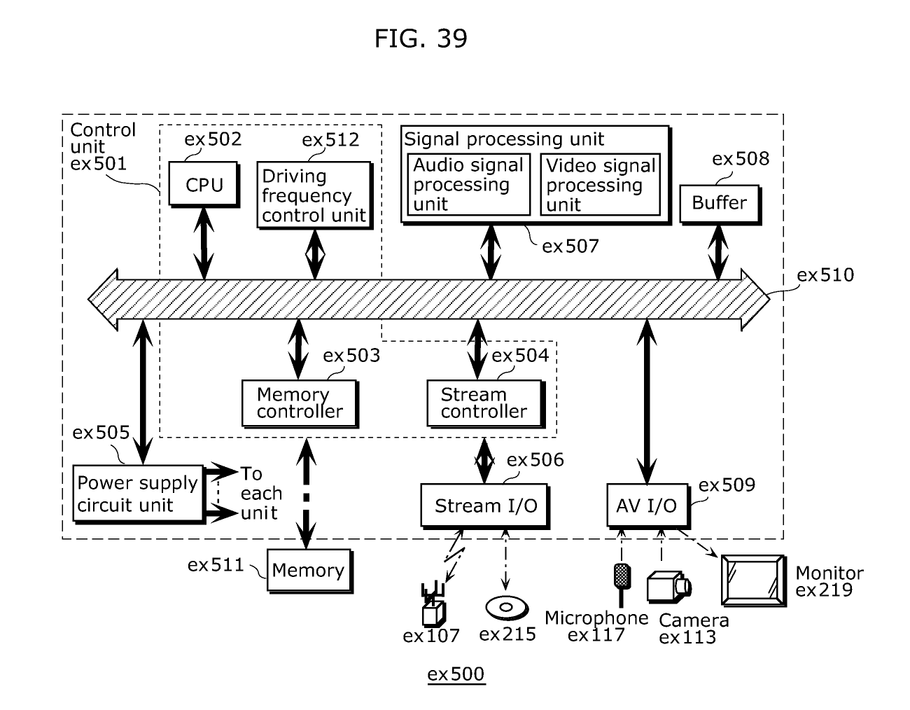

Each of the moving picture coding method, the moving picture coding apparatus, the moving picture decoding method, and the moving picture decoding apparatus in each of Embodiments is typically achieved in the form of an integrated circuit or a Large Scale Integrated (LSI) circuit. As an example, FIG. 39 illustrates a configuration of an LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of Embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording media ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, and the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

### Embodiment 6

When video data generated in the moving picture coding method or by the moving picture coding apparatus described in each of Embodiments is decoded, compared to when video data that conforms to a conventional standard, such as MPEG-2, MPEG4-AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

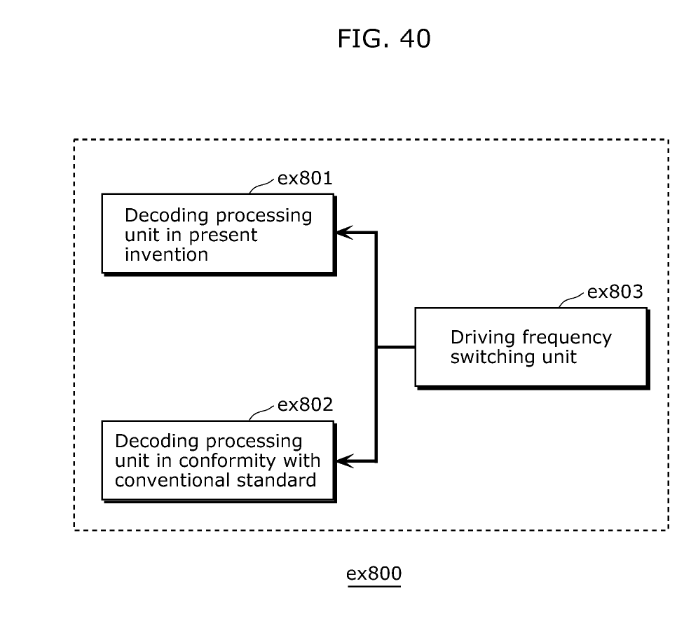

In order to solve the problem, the moving picture decoding apparatus, such as the television ex300 and the LSI ex500 is configured to determine to which standard the video data conforms, and switch between the driving frequencies according to the determined standard. FIG. 40 illustrates a configuration ex800 in this embodiment. A driving frequency switching unit ex803 sets a driving frequency to a higher driving frequency when video data is generated by the moving picture coding method or the moving picture coding apparatus described in each of Embodiments. Then, the driving frequency switching unit ex803 instructs a decoding processing unit ex801 that executes the moving picture decoding method described in each of Embodiments to decode the video data. When the video data conforms to the conventional standard, the driving frequency switching unit ex803 sets a driving frequency to a lower driving frequency than that of the video data generated by the moving picture coding method or the moving picture coding apparatus described in each of Embodiments. Then, the driving frequency switching unit ex803 instructs the decoding processing unit ex802 that conforms to the conventional standard to decode the video data.

More specifically, the driving frequency switching unit ex803 includes the CPU ex502 and the driving frequency control unit ex512 in FIG. 39. Here, each of the decoding processing unit ex801 that executes the moving picture decoding method described in each of Embodiments and the decoding processing unit ex802 that conforms to the conventional standard corresponds to the signal processing unit ex507 in FIG. 39. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 4 is probably used for identifying the video data. The identification information is not limited to the one described in Embodiment 4 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 42. The driving frequency can be selected by storing the look-up table in the buffer ex508 or in an internal memory of an LSI, and referring to the look-up table by the CPU ex502.

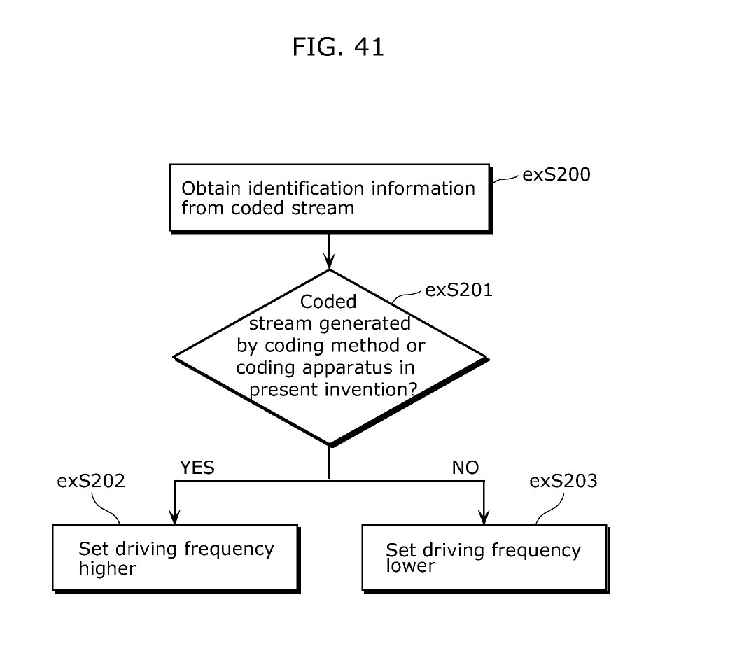

FIG. 41 illustrates steps for executing a method in this embodiment. First, in Step exS200, the signal processing unit ex507 obtains identification information from the multiplexed data. Next, in Step exS201, the CPU ex502 determines whether or not the video data is generated by the coding method and the coding apparatus described in each of Embodiments, based on the identification information. When the video data is generated by the coding method and the coding apparatus described in each of Embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG4-AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in each of Embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG4-AVC is larger than the processing amount for decoding video data generated by the moving picture coding method and the moving picture coding apparatus described in each of Embodiments, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of Embodiments, the voltage to be applied to the LSI ex500 or the apparatus including the LSI ex500 is probably set higher. When the identification information indicates that the video data conforms to the conventional standard, such as MPEG-2, MPEG4-AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in each of Embodiments, the driving of the CPU ex502 does not probably have to be suspended. When the identification information indicates that the video data conforms to the conventional standard, such as MPEG-2, MPEG4-AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in each of Embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG4-AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 7

There are cases where a plurality of video data that conforms to different standards, is provided to the devices and systems, such as a television and a mobile phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

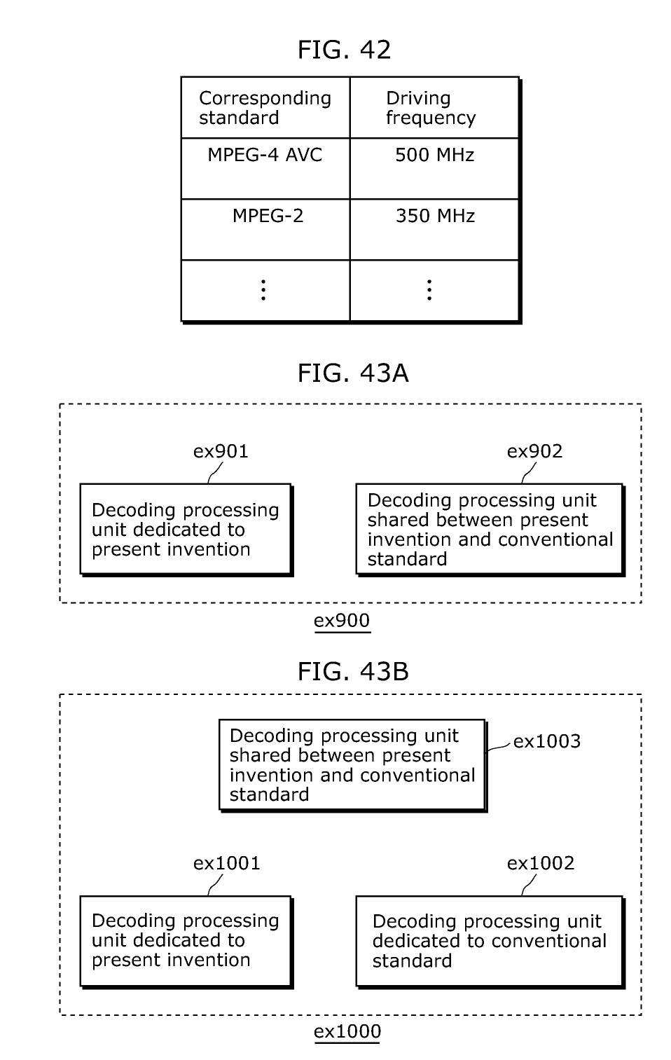

In order to solve the problem, what is conceived is a configuration in which the decoding processing unit for implementing the moving picture decoding method described in each of Embodiments and the decoding processing unit that conforms to the conventional standard, such as MPEG-2, MPEG4-AVC, and VC-1 are partly shared. An example of the configuration is shown as ex900 in (a) of FIG. 43. For example, the moving picture decoding method described in each of Embodiments and the moving picture decoding method that conforms to MPEG4-AVC have, partly in common, the details of processing, such as entropy coding, inverse quantization, deblocking filtering, and motion compensated prediction. The details of processing to be shared probably include use of a decoding processing unit ex902 that conforms to MPEG4-AVC. In contrast, a dedicated decoding processing unit ex901 is probably used for other processing that does not conform to MPEG4-AVC and is unique to the present invention. Since the present invention is characterized by entropy decoding in particular, for example, the dedicated decoding processing unit ex901 is used for entropy decoding. Otherwise, the decoding processing unit is probably shared for one of the inverse quantization, deblocking filtering, and motion compensation, or all of the processing. The decoding processing unit for implementing the moving picture decoding method described in each of Embodiments may be shared for the processing to be shared, and a dedicated decoding processing unit may be used for processing unique to that of MPEG4-AVC.

Furthermore, ex1000 in (b) of FIG. 43 shows another example in that processing is partly shared. This example uses a configuration including a dedicated decoding processing unit ex1001 that supports the processing unique to the present invention, a dedicated decoding processing unit ex1002 that supports the processing unique to another conventional standard, and a decoding processing unit ex1003 that supports processing to be shared between the moving picture decoding method in the present invention and the conventional moving picture decoding method. Here, the dedicated decoding processing units ex1001 and ex1002 are not necessarily specialized for the processing of the present invention and the processing of the conventional standard, respectively, and may be the ones capable of implementing general processing. Furthermore, the configuration of this embodiment can be implemented by the LSI ex500.

As such, reducing the scale of the circuit of an LSI and reducing the cost are possible by sharing the decoding processing unit for the processing to be shared between the moving picture decoding method in the present invention and the moving picture decoding method in conformity with the conventional standard.

### INDUSTRIAL APPLICABILITY

The image coding method and the image decoding method according to the present invention can be used in various applications such as information display devices and imaging devices with high resolution which include televisions, digital video recorders, car navigation systems, cellular phones, digital cameras, and digital video cameras.

1. An image coding method of compressing and coding image data, said method comprising:
binarizing a plurality of coefficients to generate a binary signal, the plurality of coefficients being included in a unit of processing of the image data in a frequency domain;
determining a context to be used for arithmetic coding of the plurality of coefficients, based on a position of a last non-zero coefficient in a scan order among one or more non-zero coefficients included in the unit of processing;
performing arithmetic coding on the binary signal using probability information corresponding to the determined context; and
updating, based on the binary signal, the probability information corresponding to the determined context.

2. The image coding method according to claim 1,
wherein the position of the last non-zero coefficient is represented in a two-dimensional orthogonal coordinate system, and
in said determining, the context is determined based on at least one of two coordinate values that indicate the position of the last non-zero coefficient.

3. The image coding method according to claim 2,
wherein in said determining, the context is determined based on a sum of the two coordinate values.

4. The image coding method according to claim 2,
wherein in said determining, the context is determined based only on a larger one of the two coordinate values.

5. The image coding method according to claim 1,
wherein in said binarizing, the binary signal is generated by binarizing, in a reverse order of the scan order, a level which indicates a magnitude of each of the one or more non-zero coefficients included in the unit of processing, and
in said determining, for each of the one or more non-zero coefficients included in the unit of processing, a context for arithmetic coding of the non-zero coefficient is determined based on the position of the last non-zero coefficient and the number of non-zero coefficients each of which has a level value exceeding a predetermined value among one or more non-zero coefficients located at and before the non-zero coefficient in the reverse order of the scan order.

6. An image coding apparatus which compresses and codes image data, said apparatus comprising:
a binarization unit configured to binarize a plurality of coefficients to generate a binary signal, the plurality of coefficients being included in a unit of processing in a frequency domain obtained by frequency-transforming the image data;
a context control unit configured to (i) determine a context to be used for arithmetic coding of the plurality of coefficients, based on a position of a last non-zero coefficient in a scan order among one or more non-zero coefficients included in the unit of processing and (ii) update, based on the binary signal, probability information corresponding to the determined context; and
a binary arithmetic coding unit configured to perform arithmetic coding on the binary signal using the probability information corresponding to the determined context.

7. An image decoding method of decoding compressed and coded image data, said method comprising:
determining a context to be used for arithmetic decoding of an input signal corresponding to a plurality of coefficients included in a unit of processing of the image data in a frequency domain, based on a position of a last non-zero coefficient in a scan order among one or more non-zero coefficients included in the unit of processing;
performing arithmetic decoding on the input signal using probability information corresponding to the determined context, to generate a binary signal;
updating, based on the binary signal, the probability information corresponding to the determined context; and
reconstructing, using the binary signal, the plurality of coefficients included in the unit of processing.

8. The image decoding method according to claim 7,
wherein the position of the last non-zero coefficient is represented in a two-dimensional orthogonal coordinate system, and
in said determining, the context is determined based on at least one of two coordinate values that indicate the position of the last non-zero coefficient.

9. The image decoding method according to claim 8,
wherein in said determining, the context is determined based on a sum of the two coordinate values.

10. The image decoding method according to claim 8,
wherein in said determining, the context is determined based only on a larger one of the two coordinate values.

11. The image decoding method according to claim 7,
wherein the input signal includes, in a reverse order of the scan order, a signal corresponding to a level which indicates a magnitude of each of the one or more non-zero coefficients included in the unit of processing, and
in said determining, for each of the one or more non-zero coefficients included in the unit of processing, a context for arithmetic decoding of an input signal corresponding to the non-zero coefficient is determined based on the position of the last non-zero coefficient and the number of non-zero coefficients each of which has a level value exceeding a predetermined value among one or more non-zero coefficients located at and before the non-zero coefficient in the reverse order of the scan order.

12. An image decoding apparatus which decodes compressed and coded image data, said apparatus comprising:
a context control unit configured to (i) determine a context to be used for arithmetic decoding of an input signal corresponding to a plurality of coefficients included in a unit of processing of the image data in a frequency domain, based on a position of a last non-zero coefficient in a scan order among one or more non-zero coefficients included in the unit of processing and (ii) update, based on a binary signal, probability information corresponding to the determined context;
a binary arithmetic decoding unit configured to perform arithmetic decoding on the input signal using the probability information corresponding to the determined context, to generate the binary signal; and
a coefficient reconstruction unit configured to reconstruct, using the binary signal, the plurality of coefficients included in the unit of processing.

13. An image coding and decoding apparatus comprising:
an image coding apparatus which compresses and codes image data; and
an image decoding apparatus which decodes the compressed and coded image data,
wherein said image coding apparatus includes:
a binarization unit configured to binarize a plurality of coefficients to generate a binary signal, the plurality of coefficients being included in a unit of processing in a frequency domain obtained by frequency-transforming the image data;
a context control unit configured to (i) determine a context to be used for arithmetic coding of the plurality of coefficients, based on a position of a last non-zero coefficient in a scan order among one or more non-zero coefficients included in the unit of processing and (ii) update, based on the binary signal, probability information corresponding to the determined context; and
a binary arithmetic coding unit configured to perform arithmetic coding on the binary signal using the probability information corresponding to the determined context, and
said image decoding apparatus includes:
a context control unit configured to (i) determine a context to be used for arithmetic decoding of an input signal corresponding to a plurality of coefficients included in a unit of processing of the image data in a frequency domain, based on a position of a last non-zero coefficient in a scan order among one or more non-zero coefficients included in the unit of processing and (ii) update, based on a binary signal, probability information corresponding to the determined context;
a binary arithmetic decoding unit configured to perform arithmetic decoding on the input signal using the probability information corresponding to the determined context, to generate the binary signal; and
a coefficient reconstruction unit configured to reconstruct, using the binary signal, the plurality of coefficients included in the unit of processing.
